(19) United States
(12) Patent Application Publication
(10) Pub. No.: US 2011/0145164 A1
(43) Pub. Date: Jun. 16, 2011

(54) SYSTEM AND METHOD FOR FACILITATING THE CREATION, MANAGEMENT, AND VALUATION OF SECURITIES RESEARCH

(76) Inventors: Andre G. Lavoie, Boston, MA (US); Darren J. Chun, Kingston, MA (US)

(21) Appl. No.: 12/635,568

(22) Filed: Dec. 10, 2009

(51) Int. Cl. G06Q 40/00; G06Q 99/00; G06F 15/16; G06F 3/048

(52) U.S. Cl. 705/36 R; 705/347; 709/206; 715/760

(57) ABSTRACT

A Research Management System (“RMS”) enables individuals associated with sell-side firms, buy-side firms, and/or other individuals/entities (e.g., wealth managers, corporate officers, experts, and providers and distributors of dynamic financial news reports) to create, manage, and valuate securities research. Individuals associated with a sell-side firm may generate, collaborate on, and/or publish dynamic content (e.g., assets, research reports, trade ideas) that may be tracked both internally and externally. Individuals associated with a buy-side firm may provide feedback (e.g., comments and ratings) on the sell-side content. This feedback together with other content usage metrics provide an objective measure by which buy-side firms may valuate sell-side research and other services for, among other things, determining how to allocate commissions among sell-side firms. Sell-side firms may receive selected feedback from buy-side firms on their individual performance and/or their performance vis-à-vis other sell-side firms. Sell-side firms may use the objective information they receive to better understand and appreciate how the content they generate is used and valued by their clients.

### FIELD OF THE INVENTION

The invention relates generally to a computer-implemented system and method for facilitating the creation, management, and valuation of securities research within the financial services industry.

### BACKGROUND OF THE INVENTION

Securities analysts, also referred to as research analysts or analysts, research and analyze financial data and other information to, for example, issue earnings estimates for securities, issue other financial estimates concerning future economic events (e.g., revenue), provide recommendations on whether investors should buy, sell, or hold financial instruments, and/or issue other predictions. Most securities analysts typically cover either equity securities (e.g., stocks), debt securities (e.g., bonds), or derivatives (e.g., futures, options, swaps, etc.).

Generally, securities analysts issue research reports based on their research and analysis. Research reports may include one or more of, for instance, a brief description of an entity (e.g., a corporation) to which a prediction relates, a brief prognosis on the future of the entity, earnings estimates, a buy/sell/hold recommendation, an opinionated thesis supporting the estimate or recommendation, and/or other information. Investors or other financial services professionals or individuals often consult research reports to help guide investment decisions.

Securities analysts are often employed by sell-side entities, buy-side entities, or independent entities that may sell research to sell-side entities and/or buy-side entities. For convenience, the term “entity” may be used interchangeably herein with “firm,” “institution,” or other similar descriptor, each of which are non-limiting examples of an entity. Accordingly, any such recitations should not be viewed as limiting.

Sell-side firms typically include brokerage or investment houses that, among other things, sell investment services to asset management firms (the buy-side firms). Sell-side firms employ sell-side research analysts (that generate securities research often in the form of formal, published research reports), salespeople, traders, and other individuals to generate ideas and execute trades for buy-side firms.

Buy-side firms, on the other hand, generally comprise money-management films (e.g., mutual funds, hedge funds, trusts, and pension funds) that consume sell-side services, including research generated by sell-side analysts. Buy-side firms also employ research analysts, however buy-side research analysts are tasked with identifying investment opportunities to improve the net worth of the portfolio for which they work. As such, they tend to provide research and recommendations solely for the benefit of their own money managers. While buy-side research analysts use sell-side research reports to supplement or validate their own research, buy-side research and recommendations are typically not provided to anyone outside of the buy-side firm.

Currently, certain challenges are associated with the manner in which sell-side firms are compensated for the securities research that they provide to buy-side firms. Sell-side firms, for example, have traditionally been paid for their securities research based on commissions charged on the sale price of a security. This model has two primary drawbacks. First, many buy-side firms haven't focused on what they pay for sell-side research since the cost is covered by client commissions. Second, as a result, sell-side firms have received very little in the way of feedback as to what research is most valued by buy-side firms. Many sell-side firms have therefore focused on providing an abundant amount of research in the hope that buy-side firms will consider at least some part of the research they receive to valuable.

Navigating and synthesizing content provided in numerous research reports may waste time and not necessarily add proportionate value. On the other hand, arbitrarily deciding to not read a particular research report, for instance, may cause vital information uniquely contained in that report to be missed, adversely impacting a decision.

Commission transparency efforts, both in the United States and abroad, have led many buy-side firms to implement a broker voting process to value the securities research they receive so that they can justify how their commissions are being allocated. During the broker votes, however, many people vote based on the assumption that the value of securities research should be tied to the amount of generated commissions. This method, however, often overlooks the value of other services provided by sell-side firms (e.g., one on one meetings with industry experts set-up by sell-siders, etc.) in addition to research.

These and other drawbacks exist with current methods of utilizing and valuating securities research.

### SUMMARY OF THE INVENTION

The invention addressing these and other drawbacks relates to a computer-implemented system and method for facilitating the creation, management, and valuation of securities research within the financial services industry.

According to an aspect of the invention, a Research Management System (“RMS”) may be provided as a stand-alone system and/or a component (e.g., an “add-on”) of another system, application, or platform. The RMS may be hosted by (or reside) on one or more computers associated with one or more sell-side firms, buy-side firms, or other individual(s)/entities. In one implementation, a single entity (e.g., an entity engaged in the business of compiling, providing, and/or distributing dynamic news and reports) may provide and maintain the RMS. As described herein, different features and functionality of the RMS may be made available to different users based upon, for example, their affiliation (if any) with a sell-side firm, buy-side firm, or other entity.

In one implementation, individuals associated with a sell-side firm including, for example, sell-side research analysts, salespeople, traders, a sell-side Director of Research (or other similar research or information officer) or other individuals may access the RMS. As an exemplary overview, individuals associated with a sell-side firm may, for example, generate assets (e.g., content pieces), research reports, trade ideas, and/or other dynamic information items, collaborate on these information items, and publish the information items both internally and externally. Use of the information items may be tracked both internally and externally by the RMS. Based on usage metrics and/or feedback (e.g., aggregate rating scores, comments, etc.) on the information items received from external entities (e.g., buy-side firms), sell-side firms can better understand and appreciate how the content they generate is valued by their clients. Sell-side firms may receive selected feedback from buy-side firms on their individual performance and/or their performance vis-à-vis other sell-side firms. Sell-side firms may use the objective information they receive to, among other things, manage internal resources, generate reports for commission discussions with clients, generate reports for performance reviews with employees, and/or to consider when taking other actions. User access to feedback within a sell-side firm may be managed via internal controls based on a user's position within the sell-side firm. A research director may, for example, have access to all received feedback while analysts may only have access to feedback on their own content.

Similarly, buy-side research analysts, portfolio managers, a buy-side Director of Research (or other similar research or information officer) or other individuals associated with a buy-side firm may also access the RMS for various purposes. As an exemplary overview, individuals associated with a buy-side firm may, for example, receive assets (e.g., content pieces), research reports, trade ideas, and/or other information items from sell-side firms and/or other entities. Buy-siders may also utilize the RMS to generate their own content. Buy-side content may incorporate assets dynamically accessed from information items received from sell-side firms or other entities. Use of acquired and/or newly generated information items may be tracked by the RMS. Buy-siders can provide feedback (e.g., comments, ratings, etc.) on information items received from sell-siders, as well as collaborate on their own internal information items in a number of ways. A research director or other user(s) at a buy-side firm may additionally analyze feedback (e.g., aggregate rating scores) and/or usage metrics to determine the value of research and other services received from various sell-side firms (or other entities). This information may be leveraged via an electronic broker voting system that enables one or more users associated with a buy-side fine to determine how commissions maybe allocated among each of the sell-side firms that have provided sell-side services to the buy-side firm.

In addition to sell-side firms and buy-side firms, other financial services professionals or individuals, whether independent or associated with some entity such as a Financial Information Services Provider (FISP), may also access the RMS for various purposes. Wealth managers, for example, may use the RMS to share ratings and comments with the advisors in their firm. Corporate officers may also use the RMS to access and review research on their companies as well as to provide feedback to research providers (e.g., to correct inaccuracies or provide information). Corporate officers may further use the RMS to make inquiries to targeted investors on the buy-side (e.g., to provide them with favorable research reports), as well as to answer questions asked by other individuals or firms. External financial experts (similar to brokers) that produce research reports on a subscription or pay-per-view basis may also use the RMS to allow feedback on research to be leveraged in the same manner as for sell-side firms. Individuals and/or entities engaged in the business of providing and distributing dynamic (financial) news and reports may also utilize the features and functionality of the RMS.

Various other objects, features, and advantages of the invention will be apparent through the detailed description of the preferred embodiments and the drawings attached hereto. It is also to be understood that both the foregoing general description and the following detailed description are exemplary and not restrictive of the scope of the invention.

### BRIEF DESCRIPTION OF THE DRAWINGS

FIG. 1 is an illustration of an exemplary system architecture, according to an aspect of the invention.

FIG. 2 is an illustration of exemplary modules comprising a research management system, each of which may be implemented via hardware, firmware, software, or various combinations thereof

FIG. 3 illustrates an overview of exemplary workflow operations for various users associated with a sell-side entity, according to an aspect of the invention.

FIG. 4 is an exemplary illustration of a view that may be presented to a sell-side analyst (or other user), according to an aspect of the invention.

FIGS. 5A-5B are exemplary illustrations of views that may be presented to a sell-side analyst (or other user), according to an aspect of the invention.

FIG. 6 is an exemplary illustration of a view that may be presented to a sell-side analyst (or other user), according to an aspect of the invention.

FIGS. 7A-7C are exemplary illustrations of views that may be presented to a sell-side analyst (or other user), according to an aspect of the invention.

FIG. 8 is a block diagram depicting exemplary components of a dynamic sell-side research report, according to an aspect of the invention.

FIG. 9 is an exemplary depiction of a trade idea document, according to an aspect of the invention.

FIG. 10 illustrates an overview of exemplary workflow operations for various users associated with a buy-side firm, according to an aspect of the invention.

FIG. 11 is an exemplary illustration of a view that may be presented to a user at a buy-side firm, according to an aspect of the invention.

FIGS. 12A-12D depict exemplary features and functionality enabled by a toolbar, according to an aspect of the invention.

FIG. 13 is an exemplary illustration of a view that may be presented to a portfolio manager (or other user), according to an aspect of the invention.

FIG. 14 is an exemplary illustration of a view that may be presented to a portfolio manager (or other user), according to an aspect of the invention.

FIG. 15 illustrates an overview of exemplary workflow operations associated with a process of generating and compiling data and statistics, according to an aspect of the invention.

FIG. 16 is an exemplary illustration of a view that may be presented to a buy-side research director (or other user), according to an aspect if the invention.

FIG. 17 is an exemplary illustration of a view that may be presented to a buy-side research director (or other user), according to an aspect if the invention.

FIG. 18 is an exemplary illustration of a view that may be presented to one or more users participating in a broker voting process, according to an aspect of the invention.

FIG. 19 is an exemplary illustration of a view that may be presented to a sell-side research director (or other user), according to an aspect if the invention.

FIG. 20 is an exemplary illustration of a view that may be presented to a sell-side research director (or other user), according to an aspect if the invention.

FIG. 21 is an exemplary illustration of a view that may be presented to a sell-side research director (or other user), according to an aspect if the invention.

### DETAILED DESCRIPTION OF THE INVENTION

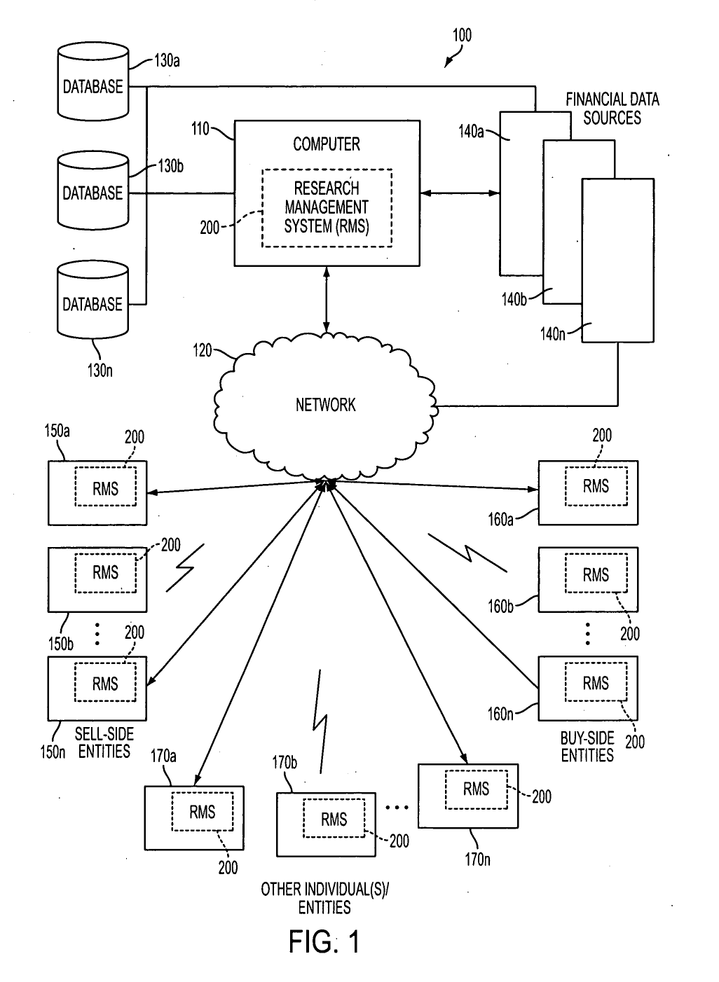

Prior to providing a detailed description of the various features and functionality enabled by the invention, an exemplary (and non-limiting) system architecture will first be described with reference to FIG. 1. It should be appreciated that implementations of the invention, as described herein, may be made in hardware, firmware, software, or various combinations thereof. The invention may also be implemented as instructions stored on a machine-readable medium, which may be read and executed using one or more processing devices. In one implementation, the machine-readable medium may include various mechanisms for storing and/or transmitting information in a form that can be read by a machine (e.g., a computing device). For example, a machine-readable storage medium may include read only memory, random access memory, magnetic disk storage media, optical storage media, flash memory devices, and other media for storing information, and a machine-readable transmission media may include forms of propagated signals, including carrier waves, infrared signals, digital signals, and other media for transmitting information. Accordingly, while firmware, software, routines, or instructions may be described herein in terms of exemplary aspects and implementations performing certain actions, it should be understood that such descriptions are merely for the sake of convenience and that such actions result from computing devices, processing devices, processors, controllers, or other devices or machines executing the firmware, software, routines, or instructions.

According to an aspect of the invention, as illustrated in FIG. 1, exemplary system 100 may include one more computers such as, for example, computer 110. Computer 110 may comprise a processor, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data which may be manipulated by the processor. The storage devices may comprise floppy disks, hard disks, optical disks, tapes, or other storage devices for storing computer-executable instructions and/or data. In one implementation, computer 110 may comprise a server which may be or include, for instance, a workstation running an operating system or platform.

According to an aspect of the invention, a Research Management System (RMS) 200 (provided and/or maintained by a service provider or other entity) may be hosted (or reside) on computer 110. RMS 200 may, for example, comprise a stand-alone system. Alternatively, RMS 200 may be a component (e.g., an “add-on”) of another system, application, or platform hosted (or residing) on computer 110. For instance, in one implementation, RMS 200 may comprise a component of the Thomson ONE Investment Analyst product offered by Thomson Reuters™ Other implementations may exist, as described below.

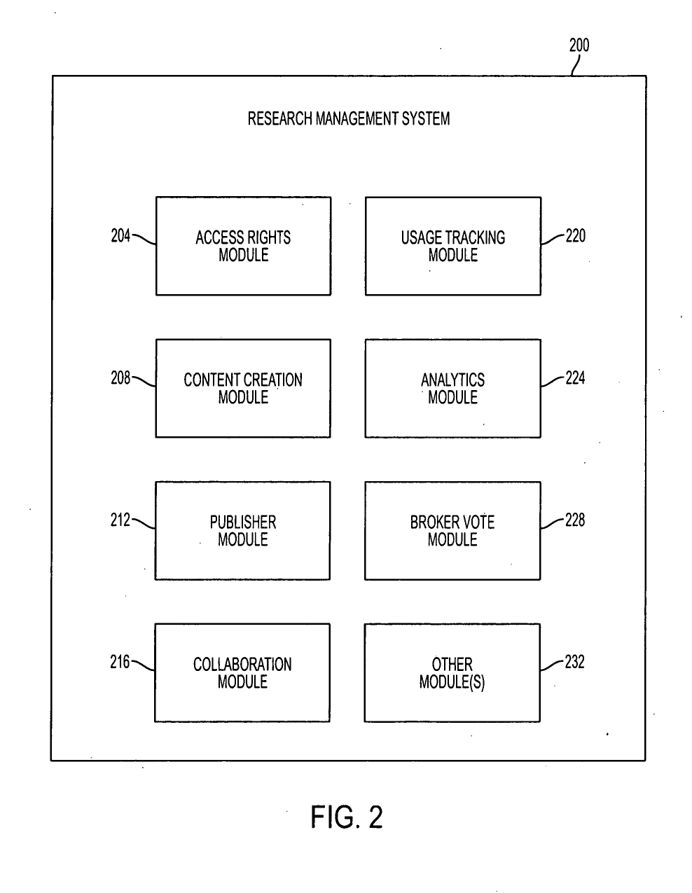

As illustrated in FIG. 2, RMS 200 may comprise a number of modules, each of which may be implemented via hardware, firmware, software, or various combinations thereof Non-limiting examples of these modules, which enable one or more of the various features and functions described in greater detail below, may include an access rights module 204, a content creation module 208, a publisher module 212, a collaboration module 216, a usage tracking module 220, an analytics module 224, a broker vote module 228, and/or other modules 232. In various implementations, one or more of the modules may be combined. For some purposes, not all modules may be necessary.

Referring back to FIG. 1, and as described in greater detail below, RMS 200 may be accessed and utilized by authorized individuals associated with a sell-side entity (or firm) (e.g., one of sell-side entities 150a, 150b, 150n), and/or a buy-side entity (or firm) (e.g., one of buy-side entities 160a, 160b, . . . 160n). Other authorized individual(s)/entities (170a, 170b, 170n) may also access RMS 200 including, for example, individuals employed by the service provider or other entity providing and/or maintaining RMS 200, as well as other financial services professionals or individuals. As explained herein, different features and functionality of RMS 200 may be made available to different users based upon, for example, their affiliation (if any) with a sell-side firm, buy-side firm, or other entity.

According to an aspect of the invention, users may access computer 110 and RMS 200 through an interface. By way of (non-limiting) example, computer 110 may comprise a web server and the interface may comprise a web browser. In one implementation, the interface may comprise a Graphical User Interface (GUI). The GUI may be displayed via a client device networked directly to computer 110, or connected to computer 110, over a network 120, via a wired or wireless communications link.

Exemplary client devices may include, but should not be limited to, workstations, desktop computers, laptop computers, Personal Digital Assistants (PDAs), wireless phones, web-enabled mobile phones, WAP devices, web-to-voice devices, or other client devices.

Network 120 may include any one or more of, for instance, the Internet, an intranet, a Personal Area Network (PAN), a Local Area Network (LAN), a Wide Area Network (WAN), a Storage Area Network (SAN), a Metropolitan Area Network (MAN), or other network. Various types of communications links may be utilized, including one or more of, for instance, a copper telephone line, a Digital Subscriber Line (DSL) connection, a Digital Data Service (DDS) connection, an Ethernet connection, an Integrated Services Digital Network (ISDN) line, an analog modern connection, a cable modem connection, wireless connection, or other connection.

According to an aspect of the invention, one or more databases (130a, 130b, . . . 130n) may be operatively connected to computer 110. Databases (130a, 130b, . . . 130n) may be, include, or interface to, for example, an Oracle™ relational database sold commercially by Oracle Corporation. Other databases, such as Informix™, Database 2 (DB2) or other data storage or query formats, platforms, or resources such as On Line Analytical Processing (OLAP), Standard Query Language (SQL), a Storage Area Network (SAN), Microsoft Access™ or others may also be used, incorporated, or accessed.

Databases (130a, 130b, . . . 130n) may store any type of data, without limitation. In one implementation, for example, databases (130a, 130b, . . . 130n) may store data provided by one or more financial data sources (140a, 140b . . . 140n). Financial data sources (140a, 140b . . . 140n) may be directly networked to computer 110, or operatively connected to computer 110 via network 120. In addition, financial data sources (140a, 140b . . . 140n) may also be directly connected to databases (130a, 130b . . . 130n), or operatively connected to databases (130a, 130b . . . 130n) via network 120. Other configurations may be implemented.

According to an aspect of the invention, financial data sources (140a, 140b . . . 140n) may include sources of analysts' predictions, research reports, or other data, and may comprise, for example, individual security analysts, institutions (e.g., brokerages), combinations thereof, or other sources. Financial data sources (140a, 140b . . . 140n) may further comprise one or more databases (e.g., Institutional Brokers Estimates Service (“IBES”) database), an Internet web site, an intranet site, or other host site or application, or any combination thereof, maintained by a financial information services provider, or other entity.

In one implementation, a data source interface module may enable RMS 200 to access, receive, store, or otherwise manage data from financial data sources (140a, 140b . . . 140n), or from databases (130a, 130b . . . 130n). In some implementations, an Application Program Interface (API) may be provided to, for example, enable third-party developers to create complimentary applications, and/or to enable content exchange with RMS 200.

It should be appreciated that the invention described herein may be implemented using any number of various system configurations. For example, RMS 200 may be configured as a web-based application, or as a client-side application (e.g., deployed/installed on a client device). RMS 200 may be additionally configured for access by users via a web browser plug-in, as executable code (e.g., a Javascript web script), as an e-mail application plug-in (e.g., for Microsoft Outlook), as a spreadsheet application plug-in (e.g., for Microsoft Excel), as a word processing application plug-in (e.g., for Microsoft Word), or as a desktop widget. RMS 200 may be further configured as a mobile application for mobile client devices.

Further, while RMS 200 has been described in one example as being hosted (or residing) on computer 110, RMS 200 may comprise a stand-alone system and/or a component of another system, application, or platform hosted by (or residing) on any number of computers associated with one or more buy-side entities (e.g., 150a, 150b, . . . 150n), one or more sell-side entities (e.g., 160a, 160b, . . . 160n), or other individual(s)/entities (e.g., 170a, 170b, . . . 170n). In one implementation, a single entity (or service provider) may provide and/or maintain computer 110, RMS 200, one or more databases (130a, 130b, . . . 130n), one or more financial data sources (140a, 140b, . . . 140n), and/or other system components. Other configurations may be implemented, without limitation.

According to an aspect of the invention, various users may access RMS 200 to utilize the features and functionality disclosed herein. For example, individuals associated with a given sell-side firm (e.g., 150a) including, for example, sell-side research analysts, salespeople, traders, a sell-side Director of Research (or other similar research or information officer) or other individuals may access RMS 200. As previously noted, sell-side firms typically include brokerage or investment houses that, among other things, sell investment services to asset management firms. As a (non-limiting) overview, individuals associated with a sell-side firm may, for example, generate assets (e.g., content pieces), research reports, trade ideas, and/or other dynamic information items, collaborate on these information items (e.g., internally) via feedback (e.g., comments, ratings, etc.) or in other ways, and publish the information items internally and externally. Use of the information items may be tracked both internally and externally by RMS 200, and based on, for example, usage metrics and/or feedback (e.g., aggregate rating scores) on the information items received from both internal and external entities (e.g., buy-side firms), sell-side firms may be able to better appreciate how the content they generate is valued. Sell-side firms may receive selected feedback from buy-side firms on their individual performance and/or their performance vis-à-vis other sell-side firms. Sell-side firms may use the objective information they receive to, among other things, manage internal resources, generate reports for commission discussions with clients, generate reports for performance reviews with employees, and/or to consider when taking other actions. User access to feedback within a sell-side firm may be managed via internal controls based on a user's position within the sell-side firm. A research director may, for example, have access to all feedback while analysts may only have access to feedback on their own content. These and other aspects are described in greater detail below.

Similarly, buy-side research analysts, portfolio managers, a buy-side Director of Research (or other similar research or information officer) or other individuals associated with a given buy-side firm (e.g., 160a) may also access RMS 200 for various purposes. Buy-side firms (e.g., mutual funds, hedge funds, trusts, and pension funds) generally consume sell-side services, including research generated by sell-side analysts. As a (non-limiting) overview, individuals associated with a buy-side firm may, for example, receive assets (e.g., content pieces), research reports, trade ideas, and/or other information items from sell-side firms and/or other entities. Buy-siders may utilize RMS 200 to generate their own assets, documents (e.g., internal research), and/or other information items which may incorporate assets (either in their original form and/or modified) dynamically accessed from internal information items as well as from information items received from sell-side firms or other entities. Use of acquired and/or newly generated information items may be tracked by RMS 200. Buy-siders can provide feedback (e.g., comments, ratings, etc.) on information items received from sell-siders, as well as collaborate on their own internal information items in a number of ways. A research director or other user at a buy-side firm may additionally analyze feedback (e.g., aggregate rating scores) and/or usage metrics to determine the value of research and other services received from various sell-side firms (or other entities). This information may also be leveraged via an electronic broker voting system that enables one or more users associated with a buy-side firm to determine how commissions maybe allocated among each of the sell-side firms that have provided sell-side services to the buy-side firm. These and other aspects are described in greater detail below.

Other financial services professionals or individuals, whether independent or associated with some entity (e.g., 170a) such as a Financial Information Services Provider (FISP) or other entity, may also access RMS 200 for various purposes. Examples may include, but are note limited to, wealth managers, corporate officers, financial experts, and individuals and/or entities engaged in the business of providing and distributing dynamic (financial) news and reports. Individuals employed by the service provider or other entity that provides and/or maintains RMS 200 may also utilize RMS 200.

In one implementation, various entities (e.g., sell-side firms, buy-side firms, etc.) or individuals may purchase licenses/subscriptions for the use of RMS 200 (and/or other systems, applications, or platforms that may include RMS 200). Other business models may be implemented, as will be appreciated by those having skill in the art. In certain implementations, access rights module 204 may enable different features and functionality of RMS 200 to be enabled or disabled for a given user depending on various factors including, for example, subscription level, affiliation with a particular entity (e.g., a sell-side fine, a buy-side firm, etc.), access permissions granted by a system administrator associated with RMS 200, access permissions granted by an administrator of a particular entity (e.g., a sell-side firm, a buy-side firm, etc.) employing the user, or other factors. In some implementations, various entities utilizing RMS 200 may become part of a shared consortium which automatically enables the sharing of certain information among members. For example, a buy-side firm that has arranged to receive securities research provided by a sell-side firm may do so via RMS 200 if both firms utilize RMS 200. Other configurations may be implemented.

The various features and functionality of RMS 200 utilized by system users will now be described. In some instances, reference will be made to various views (or screenshots) provided in the accompanying drawing figures. These views are exemplary illustrations of views that may be presented to a user of a client device accessing RMS 200 via a given interface. In various implementations, these views may differ in appearance, and include different content. Further, as illustrated and described herein, items such as a “button,” “pull-down menu,” “drop-down menu,” “tab,” “click-box,” “check-box,” “hypertext link,” “hot link,” etc. are each non-limiting examples of a generic “selection portion” which may comprise any navigational tool that enables users to select, access, display, or navigate through the features and functionality of RMS 200. The selection portions may be accessed using any various input device(s) that may be associated with a particular client device such as, for example, a keyboard, keypad, computer mouse, light stylus instrument, or finger or other body part in a touch-screen implementation. While a selection portion may be described and illustrated as a button in one implementation, it could comprise a different selection portion (e.g., a check-box) in an alternative implementation. Further, for those implementations wherein a user may access RMS 200 via a web browser, these selection portions may be present in addition to the various navigational tools that may be unique to, or associated with, the particular web browser (e.g., Firefox™) used to access RMS 200. Accordingly, the depicted views should not be viewed as limiting.

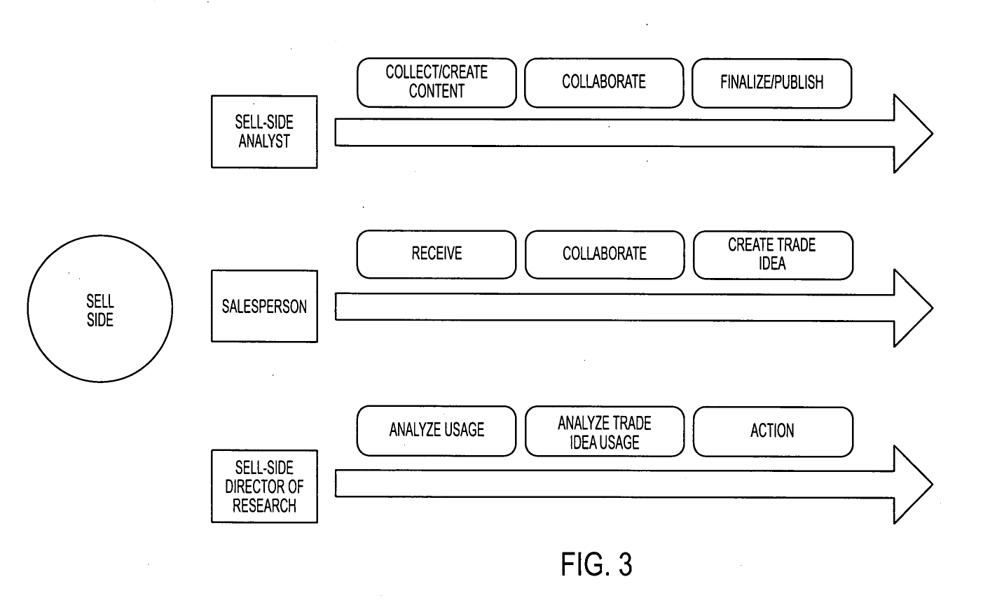

FIG. 3 illustrates an overview of exemplary workflow operations for various users associated with a sell-side firm. The described operations may be accomplished using some or all of the components of RMS 200 described in detail herein and, in some implementations, various operations may be performed in different sequences. In other implementations, various operations may not be performed at all, or additional operations may be performed along with some or all of the operations shown. In yet other implementations, one or more operations may be performed simultaneously. Moreover, while certain operations may be described as being performed by certain users, any such description should not be viewed as limiting or excluding the ability of other users to perform the operations. Accordingly, the operations described are exemplary in nature and, as such, should not be viewed as limiting.

According to an aspect of the invention, content creation module 208 may enable a sell-side analyst to collect various pieces of content from any number of sources, create new content, and manage and organize content, whether acquired or newly created. While each piece of content may be referred to herein, for example, as an asset, other similar descriptors may be used including touchpoint, content piece, content portion, or content object.

Examples of assets that may be collected or created may include, but are not limited to, text, a picture (e.g., *.jpeg or *.gif file, etc.), a screenshot, a chart, a table, a video file, an audio file, a spreadsheet or workbook (e.g., from MS Excel), a word-processing document (e.g., from MS Word), a presentation or presentation slide (e.g., from MS Powerpoint), a calendar event (e.g., from MS Outlook), a contact card (e.g., from MS Outlook), data/text files (e.g., files that contain information that isn't fully displayed), an electronic mail message, an Adobe file, a list of search results (e.g., from a web-based or other search engine), a URL, an HTML/XML file, web pages (or excerpts from them), a compressed file (e.g., a zip file), or any other types of files or portions thereof.

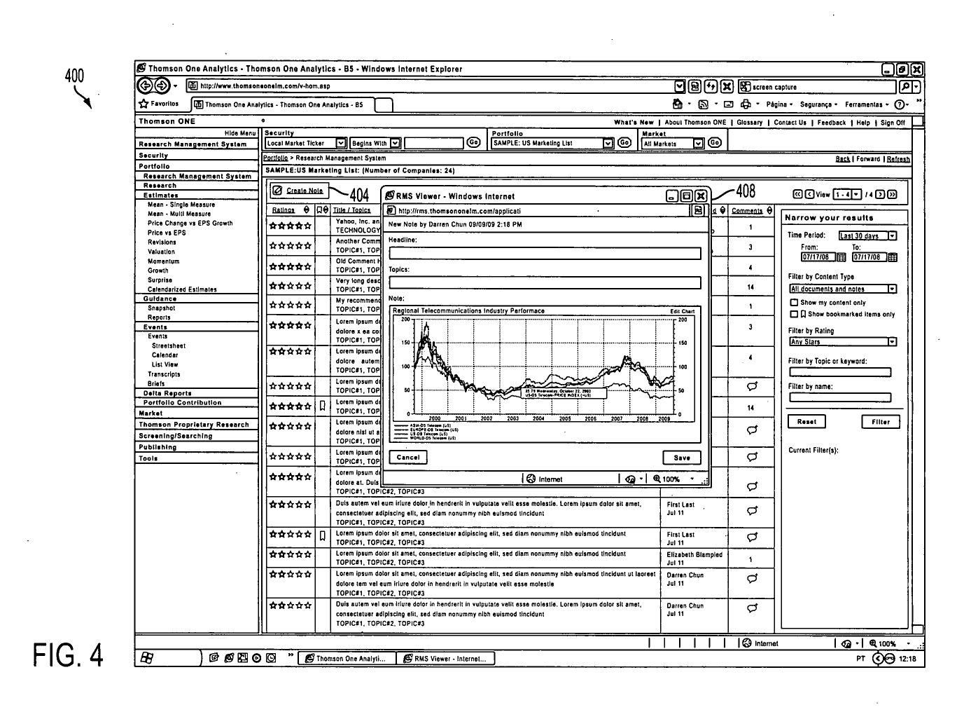

FIG. 4 is an exemplary illustration of a view 400 that may be presented to a sell-side analyst accessing RMS 200. By selecting a “create” or other selection portion 404, the sell-side analyst may be presented with a pop-up window 408 or other screen or view that enables the sell-side analyst to create and save an asset (e.g., as shown, a chart is being added as an asset).

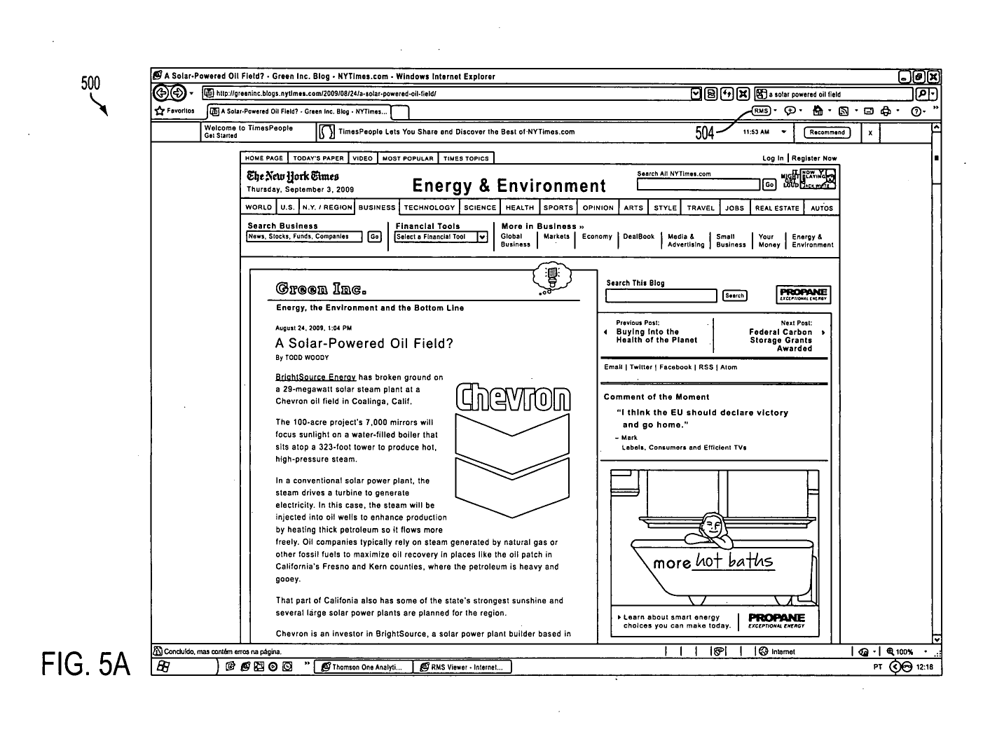

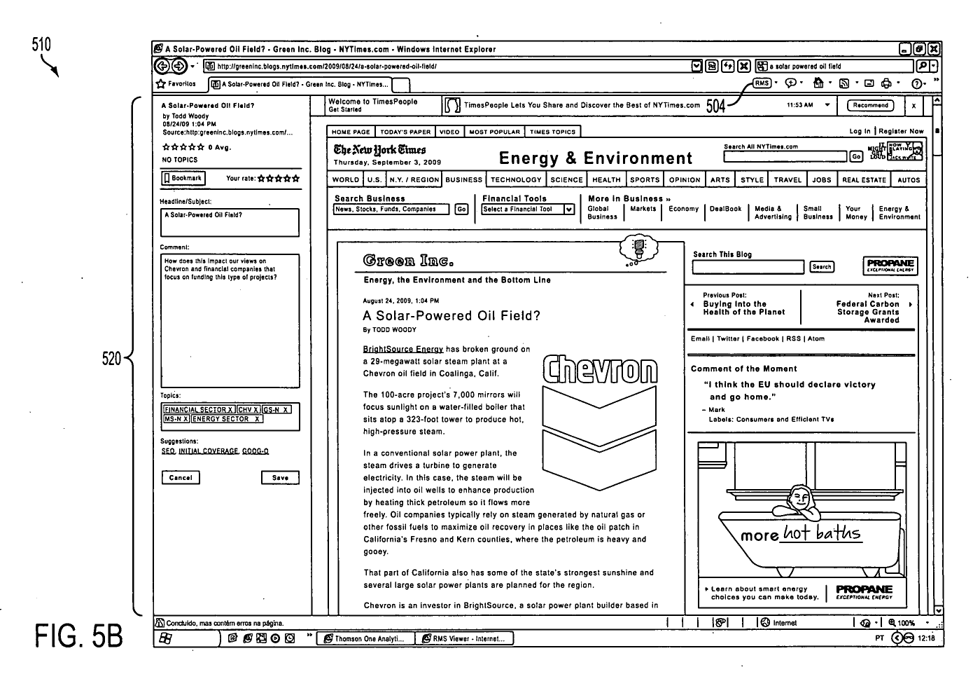

FIGS. 5A-5B are exemplary illustrations of views that a user may encounter when capturing content to create an asset. For example, in the implementation depicted in view 500 in FIG. 5A, a user may have a plug-in for RMS 200 installed on his/her browser. If an article or other piece of content displayed in the web browser is of interest, the user may select an “RMS” or other selection portion 504. As shown in view 510 of FIG. 5B, a toolbar 520 may then be displayed enabling the user to rate the content, provide a headline or subject description for the content, provide a comment, add “tags” or topic words (or select from “tags” or topic words automatically generated by the system), save the content and other data as a new asset, or perform other actions (e.g., bookmarking, etc.).

As the foregoing (non-limiting) examples demonstrate, content creation module 208 enables assets to be created, captured, tagged, and stored, and a library of assets to be compiled. In one implementation, each new asset may be assigned a unique identifier. The unique identifier may include data associating the asset with the user that created it, and/or with the firm employing the user that created it. In this regard, subsequent access and usage of the asset by various users may be tracked as described in greater detail below.

According to an aspect of the invention, stored assets may be searched or filtered using various criteria. For example, assets may be searched or filtered by one or more of topic or keyword (or tag), asset author (e.g., analyst), asset type (e.g., thesis, video, chart, etc.), firm, security, portfolio, company, industry, sector, rating (e.g., any assets having at least a predetermined rating as described below), feedback provider (e.g., an individual providing a comment and/or a rating on an asset), date or date range, or via full text searching. Assets may additionally be searched or filtered by activity counts. As described in greater detail below, activity counts may include, but are not limited to, the number of times an asset has been read, the number of times an asset has received a feedback item (e.g., a comment and/or rating), and the number of times an asset has been reused (e.g., used to create another asset, incorporated into another document in an unaltered state, and/or modified and subsequently used, as described below). As an example, a user may wish to view all assets that were used to create other assets. Other criteria may be used.

According to an aspect of the invention, publication module 212 may enable a sell-side analyst to generate a sell-side document (e.g., research report), or other type of document. Templates for various types of documents may be provided to facilitate the process of document creation. Users may also create customized templates. Research reports may include a variety of information, including, for example, a brief description of an entity (e.g., a corporation) to which a prediction relates, a brief prognosis on the future of the entity, earnings estimates, a buy/sell/hold recommendation, an opinionated thesis supporting the estimate or recommendation, and/or other information. Similar to assets, as described above, each new document may be assigned a unique identifier which may, for example, include data associating the document with the user that created it, and/or with the firm employing the user that created it. In this regard, subsequent access and usage of the document by various users may be tracked as described in greater detail below.

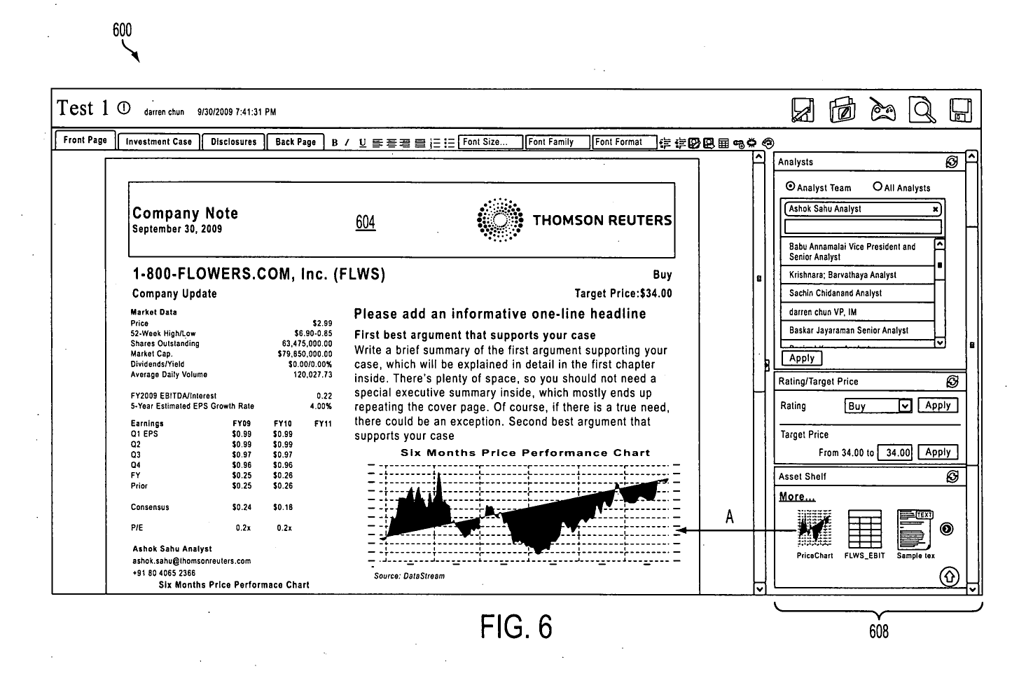

In one implementation, assets may be incorporated into documents. For example, as shown in FIG. 6, a sell-side analyst creating a research report 604 may be presented with a view 600. As illustrated, the analyst may access various assets from a displayed asset list or index 608. Asset index 608 may be populated with assets identified via a search or filtering operation using one or more of the criteria identified above. In one implementation, assets from asset index 608 may be incorporated into report 604 via, for example, a “drag-and-drop” operation as illustrated by arrow “A,” or in another manner. As such, assets may become components or portions of a research report. As described in greater detail below, assets that are incorporated into documents may be dynamically accessed by other users within the sell-side firm, as well as externally (e.g., in a buy-side firm).

According to an aspect of the invention, publication module 212 may enable sell-side analysts to “pre-submit” or publish a research report or other document for internal review or comment (e.g., to all and/or selected groups of others within the same sell-side firm) prior to finalizing the document for formal (or “official”) publication/distribution (e.g., to individuals or entities external to the sell-side firm). In some implementations, the author, a system administrator, or other user may specify which users are able to access information in the pre-submission stage.

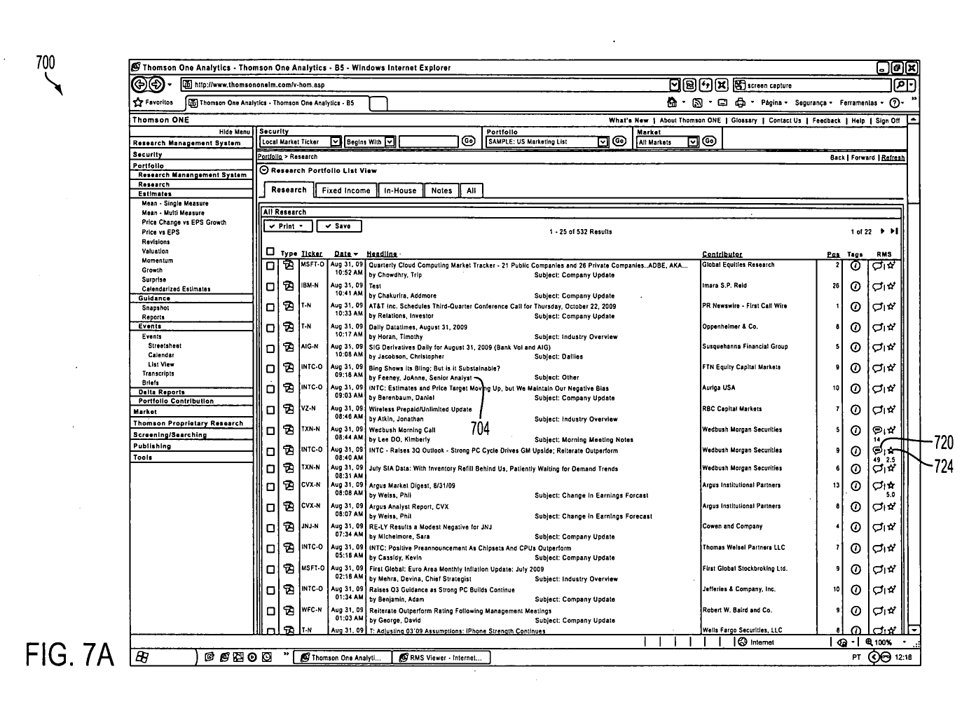

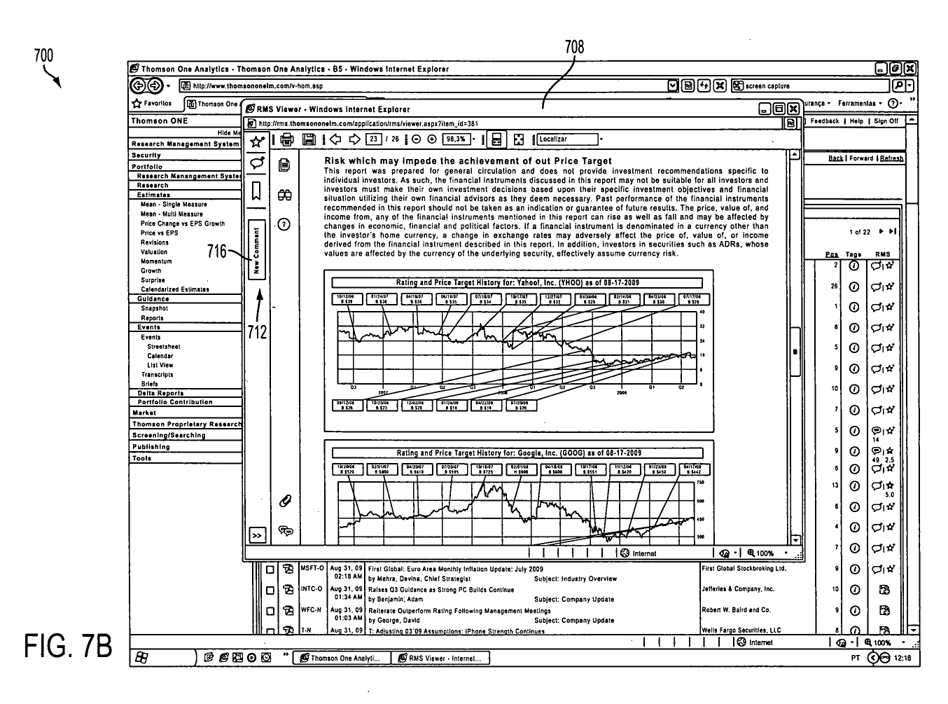

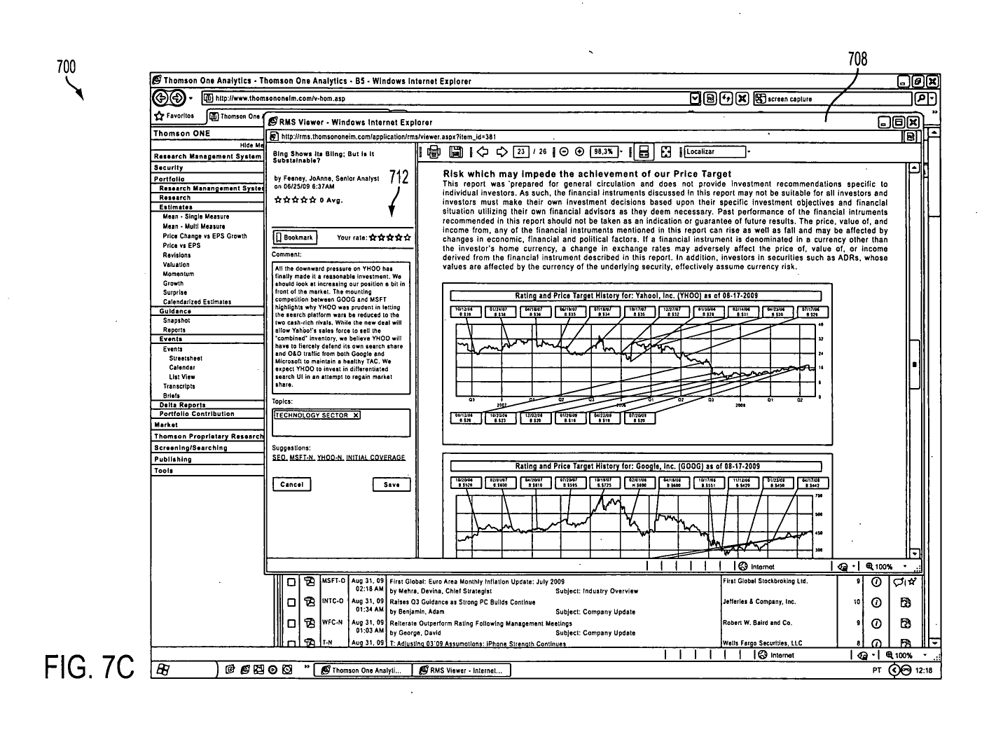

In one implementation, collaboration module 216 may enable users within a given sell-side firm to provide feedback on content created by other users within the sell-side firm, as well as view feedback provided by others. Feedback may be provided for content that has been provided in a pre-submission form, and/or finalized (e.g., formally published). As one example, a sell-side analyst may receive feedback from other individuals inside the sell-side firm on individual assets, documents, and/or particular assets within documents that the sell-side analyst has created. As shown in FIG. 7A, a user may be presented with a view 700 including a list of information items (e.g., assets, documents, etc.) in the firm library. The information items may be filtered or searched using any number of criteria such as, for example, by one or more of content type (e.g., all assets, certain asset types, all documents, certain document types, and/or all assets and documents, etc.), content that has been bookmarked or otherwise flagged, by topic or keyword (or tag), author (e.g., analyst), firm, security, portfolio, company, industry, sector, rating (described below), date or date range, and/or via other criteria. Upon selecting a desired information item (e.g., information item 704), a viewer window 708 (as shown in FIG. 7B) may appear displaying the selected information item. A toolbar 712 may also appear with the information item to enable the user to provide feedback on the information item if desired. For example, by selecting “New Comment” or other selection portion 716, toolbar 712 may expand, as shown in FIG. 7C, enabling the user to rate the content, provide a comment, add “tags” or topic words (or select from “tags” or topic words automatically generated by the system), or perform other actions (e.g., bookmarking, etc.).

One or more icons or other objects may appear in proximity to an information item in a list of information items to enable users (e.g., the creator of the information item or other user) to quickly discern whether an information item includes feedback. For example, as shown in

FIG. 7A, a comment number indicator or icon 720 may display the number of comments that have been provided for the information item thus far. A rating indicator or icon 724 may also be provided displaying an average rating applied to the information item by those that have reviewed it. Other icons or information may be conveyed. In this manner, a sell-side analyst may be alerted to the fact that others within the sell-side firm have reviewed his/her content and provided feedback. The feedback may therefore be reviewed by the sell-side analyst and considered when finalizing a research report or other document that is in the pre-submission stage, and/or when creating new content.

In some implementations, feedback provided for a document during a pre-submission stage may be deleted once the document has been formally published. In other implementations, feedback provided for a document during a pre-submission stage may continue to be associated with a document after it has been formally published, but may only be made available internally. In yet other implementations, different versions of a document may be saved along with feedback provided for each version. For example, a first version of a document may comprise an initial draft made available to selected users during a pres-submission stage, while a second version of the document may comprise the version that is formally published. Different versions and their associated feedback may be made available to selected users based on access permissions. Other possibilities may be implemented.

Additional collaborative tools may also be implemented including, for example, instant messaging functionality for collaborators, chat rooms, message boards, integration with various social networking applications, video call access, voice call access, directory look-ups, location-based tools (e.g., using GPS and/or other mapping technology), and/or other collaborative tools.

Once a sell-side analyst is satisfied with a research report or other document, the document may be published and distributed (e.g., to buy-side firms or other entities or individuals).

According to an aspect of the invention, a library of assets, documents, and/or other content may be compiled for each individual member (e.g., sell-side analyst) of a firm, or for each (sell-side) firm as a whole. In some implementations, a global library of assets may be compiled and maintained for, all users (from across a number of sell-side and/or buy-side firms). Access to a library or libraries may, for example, be based on a particular user's access rights. Other configurations may be implemented.

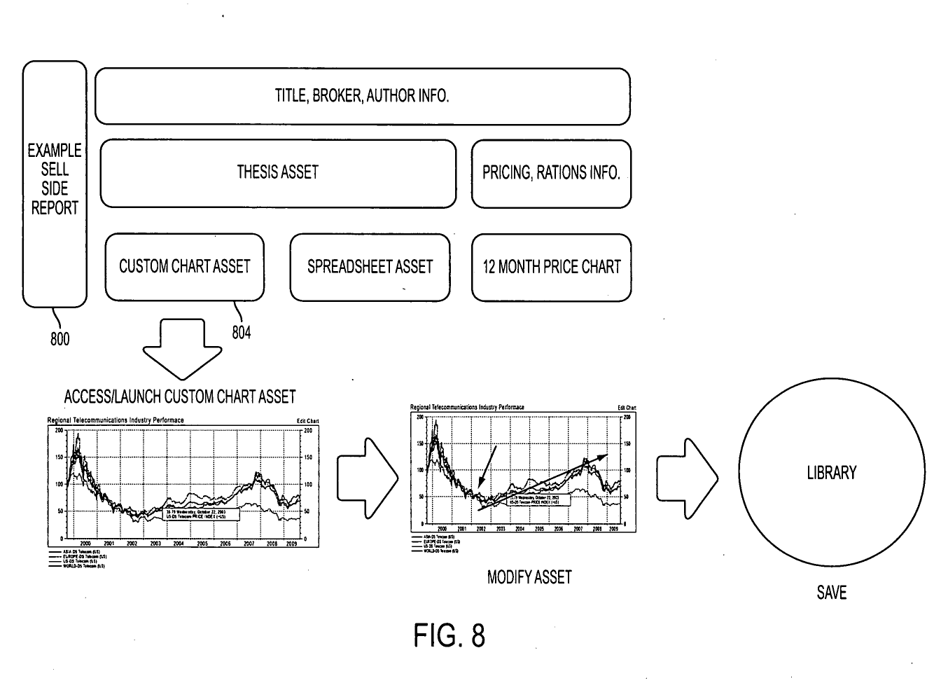

According to an aspect of the invention, documents (e.g., research reports) incorporating assets are dynamic documents, in that the incorporated assets may be dynamically accessed by one or more users. For instance, FIG. 8 depicts an example of a sell-side research report 800 that includes, among other content, a thesis asset, a custom chart asset, and a spreadsheet asset. When research report 800 is accessed by a user, the user may access or launch one or more of the individual assets comprising research report 800. As shown in FIG. 8, a user may launch an asset (e.g., custom chart asset 804), modify it, and then save it as a new asset for later use.

In one implementation, a user may access/launch an asset in a dynamic document by, for example, double-clicking on (or otherwise selecting) any portion of the asset. Additionally, or in the alternative, when a document is displayed in a viewer (or other interface), a list of assets incorporated in the document may be displayed as icons (or other representations) adjacent to (or in close proximity to) the document in the viewer (or in another window or interface). A user may dynamically launch an asset by selecting its corresponding icon (or other representation) from the asset list. Such an asset list may, for example, resemble asset index 608 as described above and illustrated in FIG. 6. An instance of the application used to create the asset may be launched in the user interface (e.g., via a plug-in). Alternatively, if the application used to create the asset is loaded on the user's client device, the application itself may be launched. In one implementation, metadata associated with an asset may ensure that the correct application is launched, as well as provide the parameters necessary to replicate the asset. For those instances wherein a user attempts to dynamically launch an asset using an application that is not available (e.g., no installed plug-in or application loaded on the user's client device), the user may be prompted to download/install the appropriate plug-in or application (e.g., from the application provider's website). Alternatively, a larger picture/view of the asset may be launched in the viewer, but without dynamic capabilities (e.g., without the ability to modify the asset, etc.) Other configurations may be implemented. In different implementations, assets may be dynamically launched from documents that are in the pre-submission stage and/or from documents that have been formally published.

In one implementation, usage tracking module 220 may track and record asset usage for later analysis. For example, one or more counters may be incremented to keep a running count of various asset usage activities. One activity count may track, for instance, the total number of times an asset has been read (e.g., accessed or launched). Another activity count may track the number of times an asset has received a feedback item (e.g., a comment and/or rating).

Activity counts may also be used to track asset reuse. An asset may be considered to be reused, for example, when it has been launched and then saved as a new asset. Asset reuse may additionally comprise incorporating an asset in another document (or other information item) in an unaltered state (e.g., without having been further modified). In some implementations, depending on the format of an asset and the application used to create it, the use of any subsequent copies of the asset (e.g., made by launching the asset and saving it) may be tracked and included in a reuse count for the asset via known tracking technology (e.g., digital signatures) and future tracking technologies.

In one implementation, if an asset is accessed, modified, and saved, the resulting asset may be treated as a new asset with a counter initiated at a zero value. The new asset may include a reference back to the original asset that it was created from. This may enable different versions of an asset to be accessed (e.g., creating an audit trail). In some implementations, separate counters may be implemented to track internal activity counts for an asset (e.g., use of an asset within a given firm) as well as external activity counts (e.g., for use outside the firm). Aggregate activity counts may also be compiled (e.g., 10 people at Firm A used this asset and 5 people from Firm B used this asset, for an aggregate use of 15). Tracking usage is valuable, for example, in that it provides an objective measure as to what data (or types of data) is being viewed most often, and therefore is presumably valued. Such metrics may be valuable to sell-side firms seeking to ensure that they are providing valued services to their consumers. Other advantages may be realized.

According to an aspect of the invention, and with reference to FIG. 3, a salesperson at a sell-side firm may utilize one or more of the features and functionality of RMS 200 described in detail above.

For example, in one implementation, a sell-side salesperson may search for, receive, or otherwise obtain or access research reports or other documents, assets, or other information items generated by sell-side analysts within their firm. A salesperson, for instance, may dynamically launch an asset incorporated in a document, modify it, and save it as a new asset, as described above with regard to FIG. 8. A salesperson may further collect and/or create their own assets via content creation module 208, as described above and illustrated in FIGS. 4 and 5A-5B.

Collaboration module 216 may further enable a sell-side salesperson to provide feedback on content created by other users within the sell-side firm, as well as view feedback provided by others. In a manner similar to that described above (and illustrated in FIGS. 7A-7C), a salesperson may provide feedback on individual assets, documents, and/or particular assets within documents, and may, for example, rate the content, provide a comment, add “tags” or topic words (or select from “tags” or topic words automatically generated by the system), or perform other actions (e.g., bookmarking, etc.).

According to an aspect of the invention, publisher module 212 may provide one or more templates to assist a salesperson in the creation of a trade idea. A salesperson may also create customized templates. Trade ideas, as known and understood by those having skill in the art, are investment ideas typically authored by a salesperson for the benefit of their valued clients (e.g., hedge funds, money managers, etc.). Trade ideas generally propose a trade in a specific security, and are usually sent to a client with a recommendation (e.g., to buy or sell), an investment value, and often include a timeframe as well as an indication of a level of conviction. Trade ideas that provide excellent returns are typically rewarded with increased commission payments.

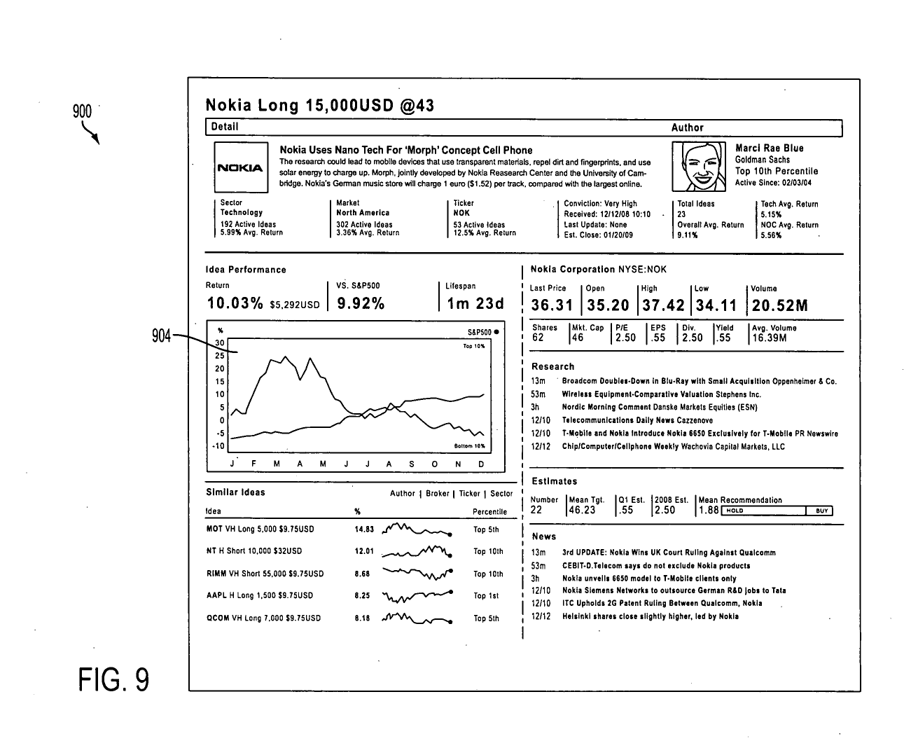

A salesperson may, via publisher module 212, build and manage their trade ideas, incorporate assets into their trade ideas, manage distribution of their trade ideas, view comments/ratings provided by others on their trade ideas (e.g., during a pre-submission stage and/or when finalized), and/or take other actions. FIG. 9 is an exemplary illustration of a trade idea 900. Similar to research reports as described above, trade ideas may also be considered dynamic documents in that the incorporated assets may be dynamically accessed by entitled recipients. For example, a user accessing trade idea 900 may launch an asset (e.g., chart 904), modify it, and then save it as a new asset for later use.

Before addressing the various operations that a sell-side director of research (or other similar research or information officer) (see FIG. 3) may perform via one or more of the features and functionality of RMS 200, it is helpful to first consider how users associated with buy-side firms may utilize RMS 200.

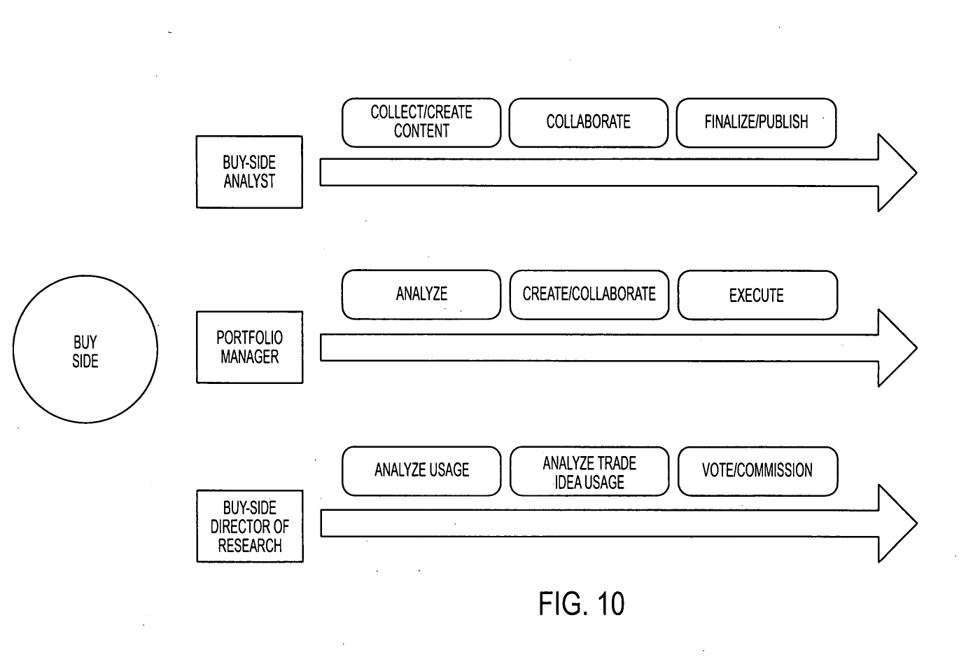

FIG. 10 illustrates an overview of exemplary workflow operations for various users associated with a buy-side firm. As previously noted, buy-side firms typically comprise money-management firms that consume sell-side services including research generated by sell-side analysts. The described operations may be accomplished using some or all of the components of RMS 200 described in detail herein and, in some implementations, various operations may be performed in different sequences. In other implementations, various operations may not be performed at all, or additional operations may be performed along with some or all of the operations shown. In yet other implementations, one or more operations may be performed simultaneously. Moreover, while certain operations may be described as being performed by certain users, any such description should not be viewed as limiting or excluding the ability of other users to perform the operations. Accordingly, the operations described are exemplary in nature and, as such, should not be viewed as limiting.

According to an aspect of the invention, content creation module 208 may enable a buy-side-side analyst to receive or collect various pieces of content from any number of sources, create new content, and manage and organize content, whether acquired or newly created. For example, a buy-side analyst may receive or access sell-side dynamic research reports or other documents from one or more sell-side firms, or other entities. The buy-side analyst may dynamically launch an asset incorporated in a document, modify it, and save it as a new asset, as described above with regard to FIG. 8. Similar to a sell-side analyst, as described above (and illustrated in FIGS. 4 and 5A-5B), a buy-side analyst may also create his or her own assets via content creation module 208.

According to an aspect of the invention, publication module 212 may enable a buy-side analyst to generate a buy-side research document (or report), or other type of document. Templates for various types of documents may be provided to facilitate the process of document creation. Users may also create customized templates. In one implementation, buy-side analysts may incorporate assets into documents that they are creating, in a manner similar to sell-side analysts as described above (and illustrated in FIG. 6).

Similar to the sell-side as described above, each new asset, document, and/or other information item generated by a user at a buy-side firm (or other firm or entity) may be assigned a unique identifier to enable usage tracking module 220 to track access and usage of the information item by various users.

According to an aspect of the invention, publication module 212 may enable buy-side analysts to “pre-submit” or publish a research report or other document for internal review or comment (e.g., to all and/or selected groups of others within the same buy-side firm) prior to finalizing the document. As previously noted, buy-side analysts typically provide research and recommendations solely for the benefit of their own money managers and, as such, buy-side research and recommendations are usually not provided to anyone outside of a buy-side firm. Accordingly, in one implementation, research reports or other documents generated by a buy-side analyst may only be made available internally to others within the analyst's buy-side firm, whether or not in draft form (e.g., pre-submission) or in final form. In some implementations, the author, a system administrator, or other user may specify which users are able to access information in the pre-submission stage.

According to an aspect of the invention, collaboration module 216 may enable users within a given buy-side firm to provide feedback on sell-side content (e.g., research reports received from sell-side firms), on content created by other users within the buy-side firm, and/or view the feedback of others.

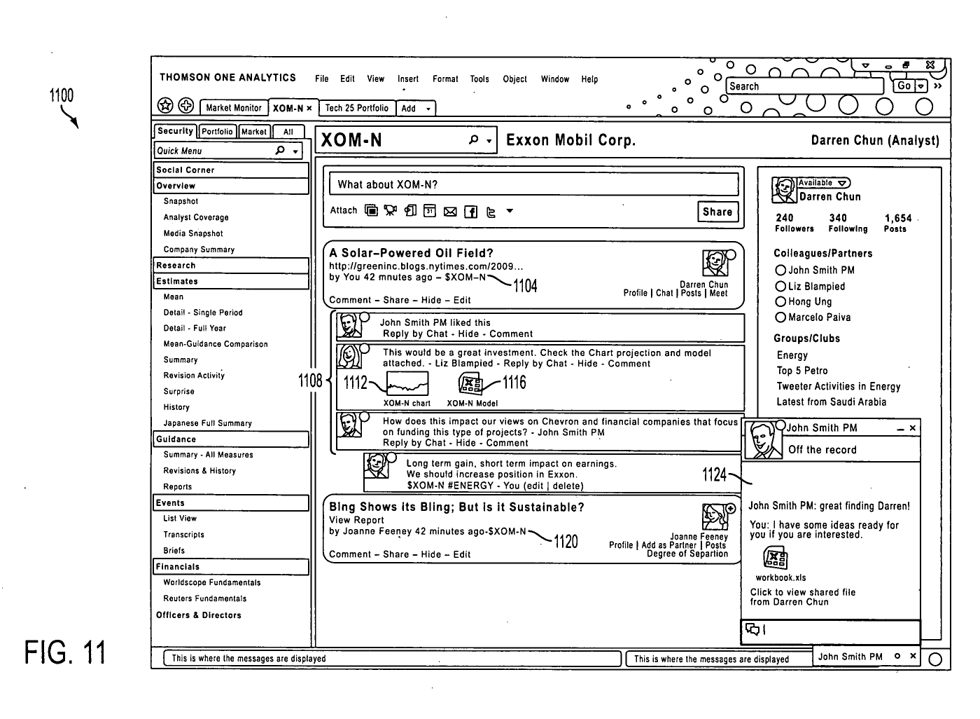

FIG. 11 is an exemplary (non-limiting) illustration of a view 1100 that may be presented. to a user (e.g., at a buy-side firm). View 100 may list a number of information items (e.g., 1104, 1120) including, for example, assets, documents, and/or other information items. For a given information item, such as item 1104, a user may view a list 1108 of one or more comments or other feedback (if any), associated with it. Comments may include assets (e.g., chart 1112 and model 1116) incorporated by collaborators. These assets may be dynamically launched, modified, and saved as new assets, if desired. Additional collaborative tools may also be implemented including, for example, instant messaging functionality for collaborators, chat rooms, message boards, and integration with various social networking applications, among others. For example, as shown in FIG. 11, a commenter may seek to communicate with the author of an information item and/or another commenter thereon via instant message (see, e.g., pop-up message window 1124).

One of the advantages provided by RMS 200 is the ability of individuals at buy-side firms to provide feedback (e.g., comments, ratings, etc.) on individual assets, documents, and/or particular assets within documents for use in subsequent analyses.

For example, according to one implementation of the invention, a user may select an individual asset, an individual document (comprising one or more assets), or other information item from a list of information items (e.g., from a list similar to that depicted in FIG. 7A).

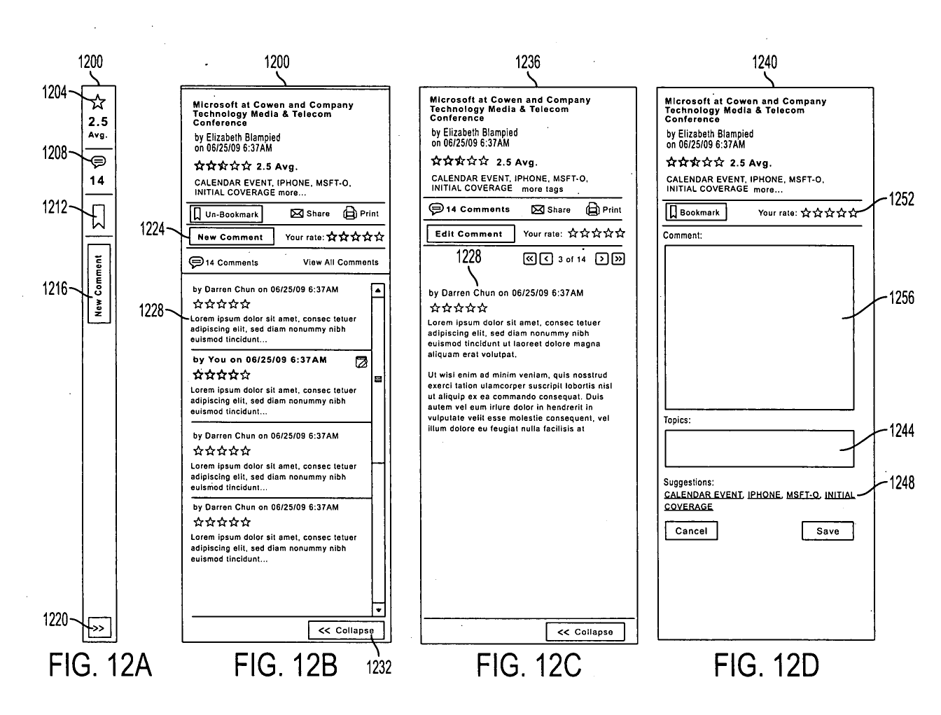

When the information item is displayed, a toolbar may appear with the information item to enable the user to provide feedback on the information item if desired. FIGS. 12A-12D depict various features and functionality of a toolbar 1200 (similar to toolbar 712 shown in FIG. 7B). that may be displayed with an information item.

As shown in FIG. 12A, for example, toolbar 1200 may initially be displayed in a “collapsed” configuration. A rating indicator or icon 1204 may display an average rating applied to the information item by those that have reviewed it. A comment number indicator or icon 1208 may display the number of comments that have been provided for the information item thus far. Selection of a bookmark icon 1212 enables the information item to be “bookmarked” or “flagged,” which may facilitate later display, search, and/or retrieval operations. A “new comment” button 1216 may be selected to enable the user to add a new comment, provide a new rating, and or convey other feedback (as will be described with reference to FIG. 12D).

A user wishing to view more detailed feedback information for the selected information item may click on selection portion 1220, which may cause toolbar 1200 to be displayed in an “expanded” configuration, as shown in FIG. 12B. Selection of button 1232 may cause toolbar 1200 to return to a collapsed configuration. According to an aspect of the invention, the expanded configuration may, for example, enable a user to scroll through (and quickly preview) the comments that have been provided on the information item. Selecting a particular comment (e.g., comment 1228), may result in the display of the entire comment in a new view 1236, as shown in FIG. 12C.

Selection of “new comment” button 1216 (FIG. 12A) and/or “new comment” button 1224 (FIG. 12B) may cause a view 1240 (as shown in FIG. 12D) to be displayed enabling the user to provide his/her own feedback on the associated information item. For example, the user may provide a rating 1252 for the information item. While a possible rating of “0” to “5” stars is depicted, other rating scales may be implemented. A user may also enter a comment in comment field 1256, enter “tags” or topic words for the comment in field 1244, and/or select from “tags” or topic words automatically generated by the system and displayed in field 1248. Other types of feedback may be provided. Once a user has saved his/her feedback, the rating provided (if any) may be reported to analytics module 224 to be used in subsequent analyses (described below).

According to an aspect of the invention, toolbar 1200 may be used to provide feedback for an individual asset, or an individual document (e.g., a sell-side research report) as a whole. For those instances wherein a user may wish to provide feedback on an individual asset within a document or other information item, he or she may dynamically launch the asset within the document (as described above) in order to view the toolbar 1200 (associated with the asset) to provide feedback. Other configurations may be implemented. For example, in some implementations, a list of assets incorporated in a document may be displayed as icons (or other representations) adjacent to (or in close proximity to) the document in the viewer (or in another window or interface). This asset list may, for example, resemble asset index 608 as described above and illustrated in FIG. 6. If a user wishes to provide feedback on an individual asset within a document without actually launching the asset, he or she may select (or highlight) its corresponding icon (or other representation) from the asset list. Toolbar 1200 may then become active for the selected asset (e.g., any comments, ratings, or other feedback provided via toolbar 1200 will be applied to the selected/highlighted asset).

Referring back to FIG. 10, once a buy-side analyst is satisfied with an internal research report or other document, the document may be published internally.

According to an aspect of the invention, a library of assets, documents, and/or other content may be compiled for each individual member (e.g., buy-side analyst) of a firm, or for each (buy-side) firm as a whole. In some implementations, a global library of assets may be compiled and maintained for all users (from across a number of sell-side and/or buy-side firms). Access to a library or libraries may, for example, be based on a particular user's access rights. Other configurations may be implemented.

In one implementation of the invention, and with reference to FIG. 10, a portfolio manager (or other individual) at a buy-side firm may utilize one or more of the features and functionality of RMS 200 described in detail above. A portfolio manager is typically the person (or one of the people) responsible for investing a given fund's assets, implementing its investment strategy, and managing the day-to-day portfolio trading. Accordingly, a portfolio manager may utilize RMS 200 to quickly access and analyze information that is most pertinent to his or her portfolio. This information may include documents published by sell-side firms (e.g., research reports, trade ideas, etc.), internal documents published by buy-side analysts, or other information.

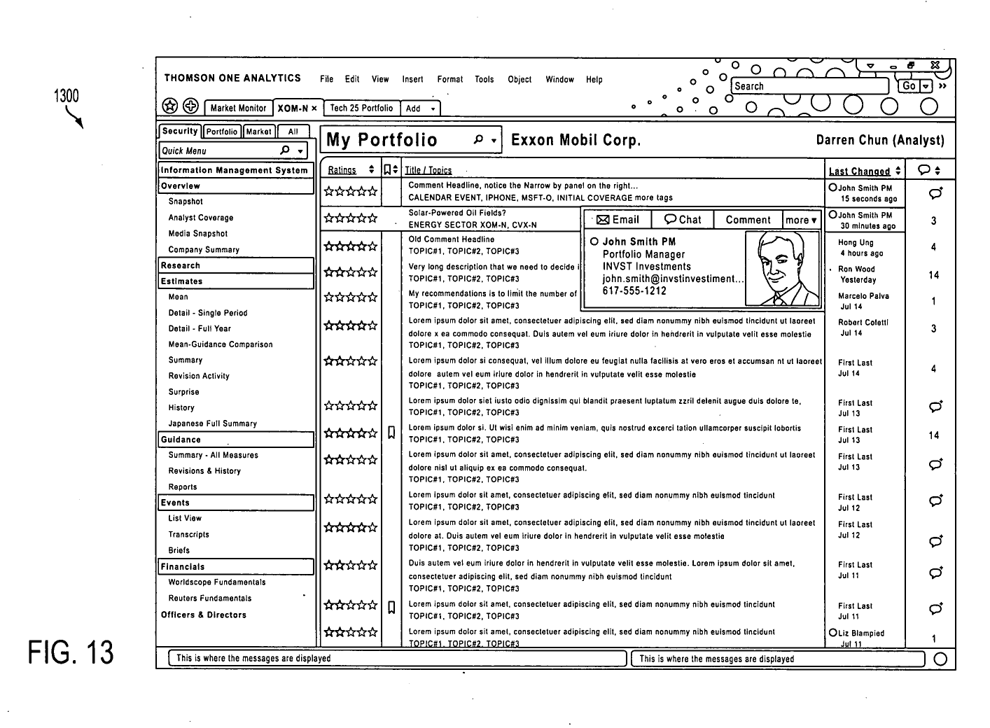

As illustrated in FIG. 13, a portfolio manager may be presented with a view 1300 including a list of information items (e.g., assets, documents, etc.). The information items may be filtered or searched using any number of criteria such as, for example, by one or more of content type (e.g., all assets, certain asset types, all documents, certain document types, and/or all assets and documents, etc.), content that has been bookmarked or otherwise flagged, by topic or keyword (or tag), author (e.g., analyst), firm, security, portfolio, company, industry, sector, rating (described below), date or date range, and/or via other criteria. As one non-limiting example, a portfolio manager may search for (or access) a particular type of asset (e.g., a thesis) from any available research reports and/or other documents covering a particular company (e.g., Microsoft). Upon reviewing a particular thesis, the portfolio manager may decide to launch the full research report containing the thesis to view additional information. In one implementation, assets may include reference pointers to each of the documents that use them, and vice versa. Accordingly, for a selected asset, a user may be prompted to select which document, from among the documents incorporating the selected asset, to access via a “click-through” (or other) operation. In this regard, a user can search for an asset, view it, and then quickly access any of the documents that may include it.

According to an aspect of the invention, a portfolio manager may dynamically launch an asset incorporated in a document, modify it, and save it as a new asset. A portfolio manager may also collect and/or create their own assets via content creation module 208. Additionally, communication with other users (within the same buy-side firm, as an example) may occur via chat room, instant messaging, message boards, or other collaborative tools or applications (e.g., via an interface similar to that described above and illustrated in FIG. 11).

A portfolio manager may further collaborate with others by providing feedback on individual assets, individual documents (comprising one or more assets), or other information items using a toolbar, such as toolbar 1200 described above and illustrated in FIGS. 12A-12D. For example, a portfolio manager may apply comments/ratings to research reports, trade ideas, and other information items generated either by the sell-side, or internally.

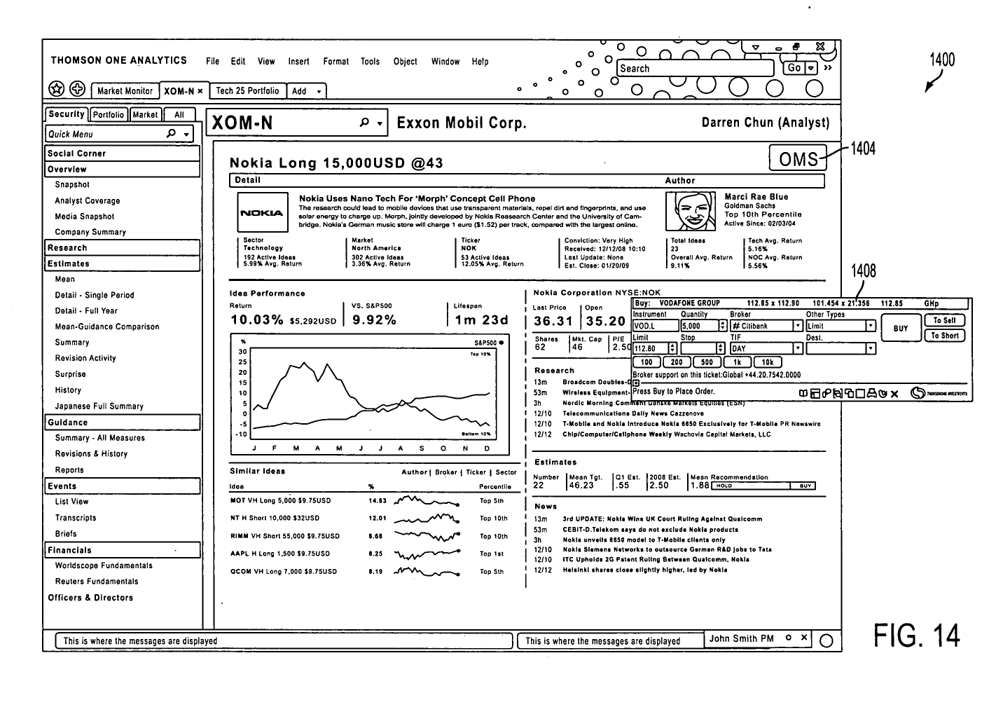

According to an aspect of the invention, RMS 200 may include or interface to an order management system or other financial system, application, or platform, thereby enabling a portfolio manager to execute various actions. For example, as shown in FIG. 14, a view 1400 displaying a trade idea or other document may include a selection portion (e.g., “OMS” button 1401) that, when selected, may launch a window 1408 enabling a portfolio manager to execute a transaction (e.g., a buy or sell order). A portfolio manager (or other user) may also, for instance, apply trade ideas to (or take other actions with respect to) a hypothetical portfolio to see the impact of a contemplated transaction. For example, a portfolio manager may view the impact that a purchase of 100 shares of Company A stock might have on a hypothetical portfolio. A portfolio manager (or other user) may additionally execute risk management models to analyze the risk associated with hypothetical trades. Additional actions may be taken.

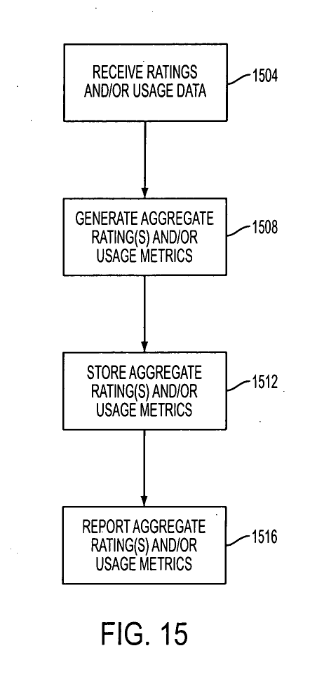

FIG. 15 illustrates an overview of exemplary workflow operations associated with a process of receiving ratings and usage data for various information items, and generating and compiling data and statistics for subsequent analysis and use in decision-making processes undertaken by various users of RMS 200. The described operations may be accomplished using some or all of the components of RMS 200 described in detail herein and, in some implementations, various operations may be performed in different sequences. In other implementations, various operations may not be performed at all, or additional operations may be performed along with some or all of the operations shown. In yet other implementations, one or more operations may be performed simultaneously. Accordingly, the operations described are exemplary in nature and, as such, should not be viewed as limiting.

In an operation 1504, analytics module 224 may receive ratings from various sources for various information items. As previously described herein, various users of RMS 200 may provide ratings on individual assets, individual documents, assets within documents, and/or other information items. For example, as noted above with regard to FIGS. 7A-7C, sell-side analysts and sell-side salespersons (among other users) may provide ratings for information items published internally within a particular sell-side firm. Similarly, as previously described with regard to FIGS. 12A-12D, buy-side analysts and buy-side portfolio managers (among other users) may provide ratings for information items published internally (within a particular buy-side firm), as well as information items received from various other entities (e.g., one or more sell-side firms). For illustrative purposes only, a rating scale of “0” to “5” stars has been described herein and illustrated in many of the accompanying drawing figures. Other rating scales may be implemented. Raw ratings data received by analytics module 224 may be stored and/or archived.

According to an aspect of the invention, analytics module 224 may additionally receive usage data from usage tracking module 220 on the number of times individual assets, individual documents, assets within documents, and/or other information items have been accessed (e.g., launched) by various users of RMS 200. As previously recited, a counter (or other mechanism) associated with each information item may enable such data to be tracked and recorded. Raw usage tracking data generated by, and received from usage tracking module 220, may be stored and/or archived.

In an operation 1508, analytics module 224 may use the received ratings and tracking data in various calculations. In one implementation, an aggregate rating score may be generated by averaging every rating received for a given information item over a pre-determined time period (e.g., a day, week, month, quarter, half-year, year, etc.). An aggregate rating score may, for example, be generated for an individual asset, for an individual document based on ratings of the document as a whole, and/or for an individual document based on an average of the aggregate rating scores generated for each individual asset included in the document. Moreover, the scores may be generated using ratings provided by an individual (e.g., an analyst), by a firm (e.g., all analysts or other individuals in a given firm that have provided ratings), by multiple firms (e.g., an agreement between one or more firms may enable ratings to be shared across firms), using all ratings available from all possible sources, or using some subset of the above.

In one implementation, aggregate rating scores may be normalized based on, for example, an average rating applied by a user, an average rating applied by a firm (e.g., a buy-side firm), and/or other factors. As an example, “Analyst A” may generally give higher ratings (e.g., an average of 4 out of 5 stars) for each information item rated during a given time period, while “Analyst B” may generally award lower ratings (e.g., an average of 3 out of 5 stars) for each information item rated during the same time period. Therefore, if Analyst A and Analyst B each award a maximum rating of 5 to a particular information item (e.g., sell-side research “Report X”), Analyst A's normalized rating for Report X may be calculated as “1.25” (e.g., the instant rating of “5” divided by Analyst A's average rating applied of “4”), while Analyst B's normalized rating for Report X may be calculated as “1.67” (e.g., the instant rating of “5” divided by Analyst B's average rating applied of “3”). Therefore, because Analyst B is a lower grader than Analyst A, his/her award of a “5” may be worth more than Analyst A's award of a “5.” Normalizing ratings assists in generating more meaningful metrics by accounting for, among other things, grade inflation. Similar normalization methods may be implemented when comparing ratings among firms (e.g., when comparing how buy-side “Finn A” as a whole rated a particular information item (e.g., sell-side research “Report Y”) vis-à-vis ratings of “Report Y” provided by buy-side “Finn B,” Firm C,” “Finn D,” etc. Other normalization and/or weighting techniques may be implemented.

Analytics module 224 may further generate usage metrics based on, for example, usage data received from usage tracking module 220. Examples of the usage metrics may include metrics on any of the activity counts as described above including, for example, a total number of access counts for an individual asset over a predetermined time period, a total number of access counts for an individual document over a predetermined time period, the total number of access counts for an asset within a document over a predetermined time period, and/or a total number of counts of reuse of an asset in one or more documents over a predetermined time period. Other usage metrics may be determined. Similar to the scores as described above, usage metrics may further be generated using data for an individual, a firm, multiple firms, using all metrics available from all possible sources, or using some subset of the above.

According to an aspect of the invention, calculations in operation 1508 may be performed for one or more information items (e.g., determine an aggregate rating score or usage metrics for a given asset, document, etc.), for one or more analysts or authors (e.g., determine an aggregate rating score or usage metrics for an analyst or author based on his/her body of work), for a firm (e.g., for all content produced by a sell-side firm or other entity), for a sector, for a given security, or for other targets.

According to an aspect of the invention, calculations determined in operation 1508 may be used to identify, among other things, the highest rated information items (e.g., assets, documents, etc.), the most read information items (based, for example, on access counts), the documents with the most used assets, the highest rated analysts, the highest rated firm, etc. Any of the foregoing may be categorized by overall, by sector, by company, by time period(s) (e.g., 1^{st} quarter versus 2^{nd} quarter, etc.), by asset type (e.g., who produces the best theses, best charts etc.), and/or by information item type (e.g., best asset, research report, trade idea, etc.). Other categorizations may be used. Additionally, the calculations may be used generate any type of comparison data (e.g., Analyst A ranked 1^{st} in particular category for a given time period but slipped to 4^{th} in the same category during a subsequent time period).

In some instances, a sell-side firm may receive aggregate rating scores and/or usage metrics for its analysts or other individuals based on internal ratings/usage (from within the sell-side firm). A sell-side firm may further receive this information (or portions thereof) based on ratings/usage provided by various external entities (e.g., buy-side firms) as described in greater detail below. A buy-side firm may also receive aggregate rating scores and/or usage metrics for its analysts or other individuals based on internal ratings/usage (from within the buy-side firm). Other implementations may exist.

In an operation 1512, analytics module 224 may store and/or archive some or all of the aggregate rating scores and/or usage metrics determined in operation 1508.

In an operation 1516, some or all of the aggregate rating scores and/or usage metrics determined in operation 1508 may be reported (e.g., made available) within RMS 200 itself, as well as in one or more formats (e.g., via electronic mail, web access, SMS-based messaging, facsimile, or via other forms of communication) to various users of RMS 200 based on access rights, as described in greater detail below. This information may reduce the amount of time expended on navigating and analyzing research used to make decisions. As an example, a user may choose to only consult information items having some minimum rating (e.g., 4 stars or higher). Other advantages may be realized.

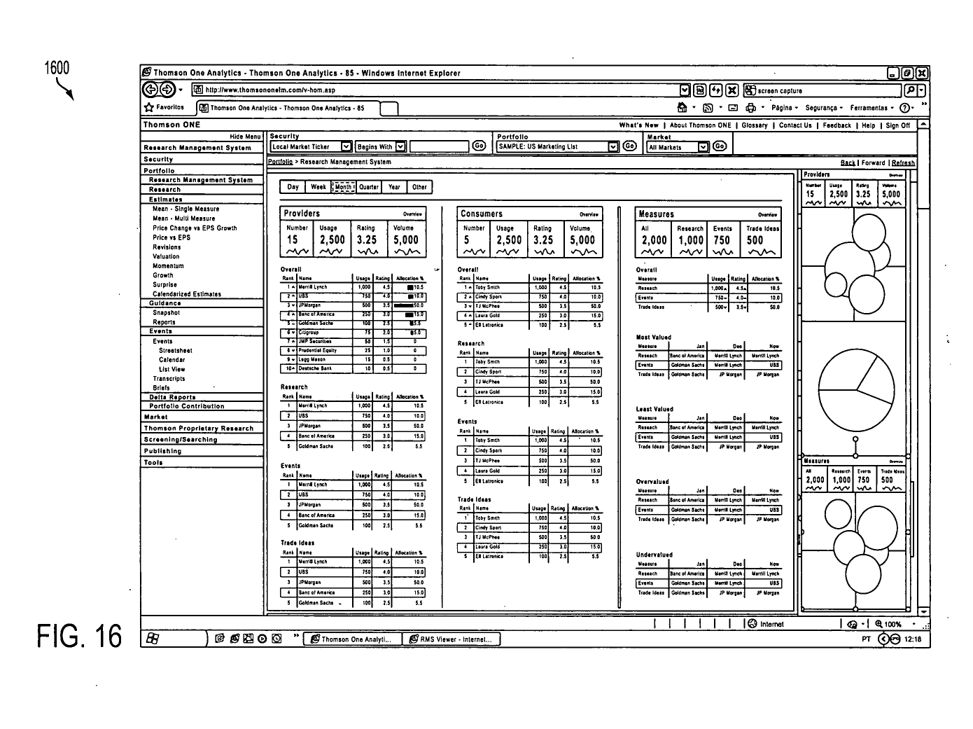

According to an aspect of the invention, and with reference back to FIG. 10, a director of research (or other similar research or information officer) at a buy-side firm may analyze data generated by analytics module 224 to, among other things, determine the value of research received from various sell-side firms (or other entities). For example, a buy-side research director may access view 1600 (as shown in FIG. 16) and, for a predetermined time period (e.g., a day, week, month, quarter, half-year, year, etc.), review usage of assets, research documents, trade ideas, models, etc. to identify consumption trends and determine which sell-side entities have provided the most value to the buy-side firm.

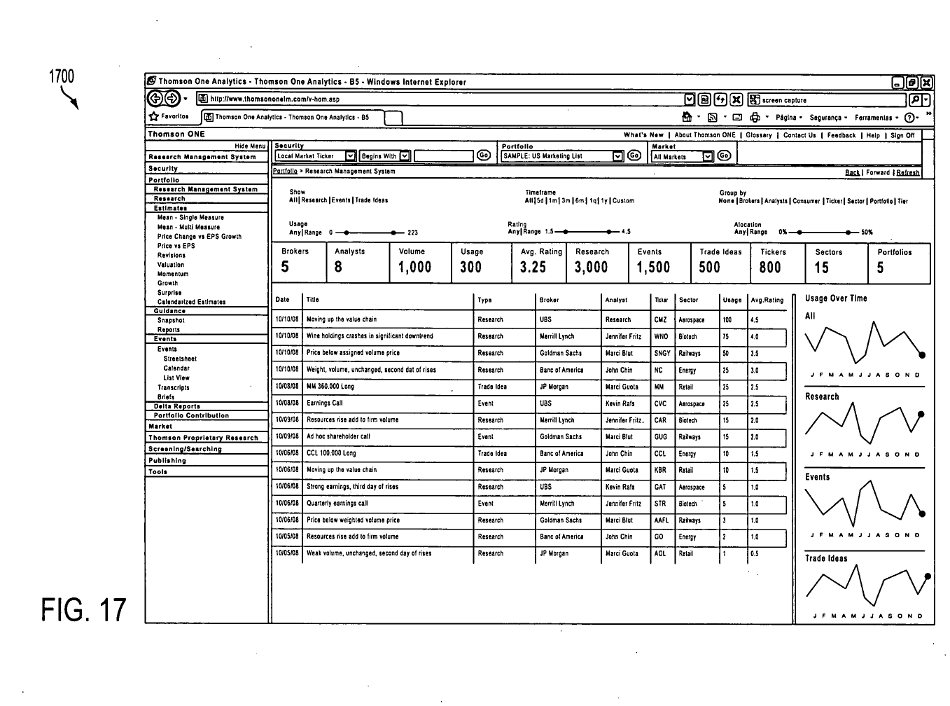

In one implementation, a buy-side director of research may analyze usage of trade ideas received from one or more sell-side firms (or other entities). FIG. 17 depicts an exemplary illustration of a view 1700 that enables a buy-side research director to view various metrics including, for example, volume and performance of trade ideas. Usage is tracked and displayed to be as actionable as possible. For instance, volume and performance of trade ideas may be filtered by broker, analyst, or via other criteria. A buy-side research director may view firm execution attributed to various trade ideas and also determine the value of the trade ideas produced. A buy-side director of research may further manage research services across type, as well as by broker, sector, internal user, or portfolio (among other examples).

According to an aspect of the invention, broker vote module 228 provides an intelligent broker voting system that enables one or more users associated with a buy-side firm to determine how commissions may be allocated among each of the sell-side firms that have provided sell-side services to the buy-side firm. Typically, each analyst or other individual that interacts with a broker or other individual at a sell-side firm gets to vote. In one implementation, at the end of a predetermined time period, various reports may be generated, via analytics module 224, enabling a buy-side firm to evaluate, among other things, aggregate information (e.g., aggregate rating scores) for individual analysts, as well as for a brokerage/sell-side firm as a whole (based on all analysts associated with that sell-side firm). In this regard, a buy-side firm may objectively compare—side-by-side—the performance of all different sell-side firms from which sell-side services are received to see how they rank against one another. These reports may be used to facilitate internal discussions on commissions payouts.

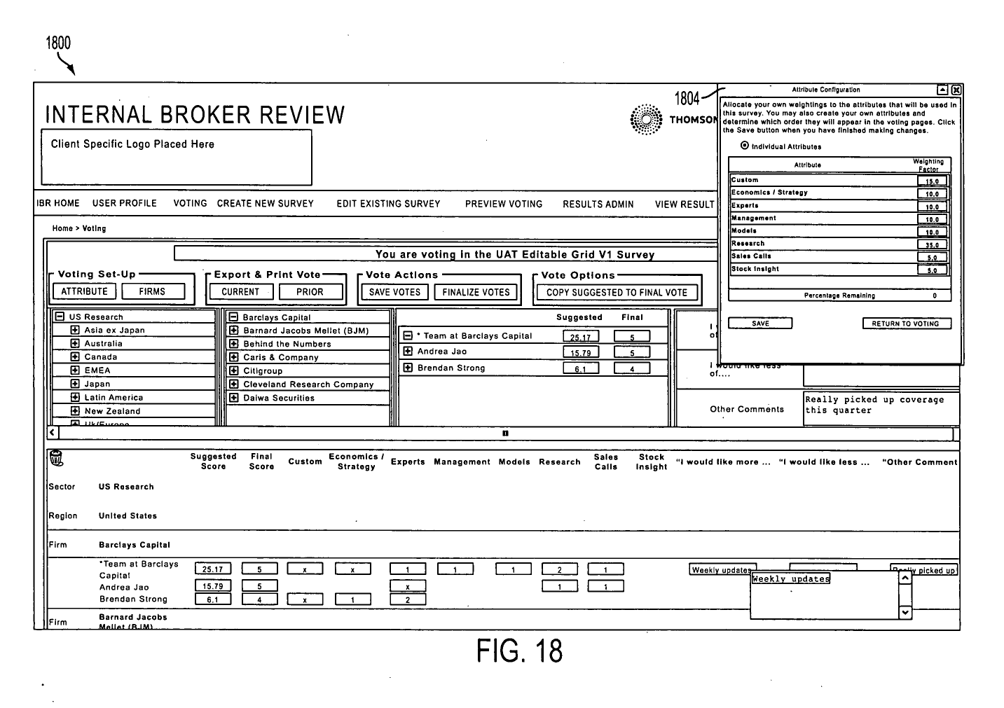

In one implementation, users participating in a broker voting process may each be presented with a view 1800, as displayed in FIG. 18, enabling them to submit for consideration their individual broker votes electronically.

Broker vote module 228 may additionally enable each user to determine their own broker vote methodology. For example, as shown in FIG. 18, a window 1804 may be displayed to a user to enable the user to allocate weights to individual attributes (whether default or custom-created) used in the overall determination of a commission payout. For instance, a user may assign weights (in one example, percentages) to attributes based on the level of importance of the attributes when valuating sell-side services. A user may allocate weights to attributes such as research, sales calls, stock insights, models, experts, economics/strategies, or other custom attributes. A user may, for example, feel that meetings with industry insiders arranged by sell-siders are more valuable than research received from sell-siders, and may therefore assign different weights to these two attributes accordingly. Other implementations may be utilized. In some implementations, individuals within a firm may select one or more attributes of their own choosing (e.g., each individual may use different attributes). In other implementations, a firm may provide a standardized list of attributes to be used by individuals “firm-wide.”

Broker vote module 228 may enable a user to view various types of objective information for a brokerage/sell-side firm to assist the user in valuating the services received from the firm in order to make an intelligent decision regarding a commission payout. As a non-limiting example, a user may view aggregate information (e.g., aggregate rating scores as well as usage metrics concerning activity counts for readership and reuse of assets, etc.) for individual analysts, as well as for the brokerage/sell-side firm as a whole (based on all analysts associated with that sell-side firm). The user may also elect to view such data calculated using his/her ratings alone (e.g., how did the user alone rate assets, reports, and/or other information items or services provided by the sell-side firm), or using the ratings applied by all individuals within his/her own firm. In one implementation, an analyst vote may be conducted to determine the best analysts in their respective fields from one or more firms (e.g., as a result of a survey, for “bragging rights,” etc.). A user may therefore similarly view various types of objective information (e.g., aggregate rating scores, usage metrics, etc.) for analysts for one or firms, and may elect to view such data calculated using his/her ratings alone, or using the ratings applied by all individuals within his/her own firm and/or other firms.

In one implementation, broker vote module 228 may utilize aggregate rating scores and usage metrics for individual analysts at sell-side firm and/or for the sell-side firm as a whole (based on all analysts associated with that sell-side firm) to generate a recommended commission payout for the sell-side firm.

According to an aspect of the invention, and with reference back to FIG. 3, a director of research (or other similar research or information officer) at a sell-side firm may receive feedback from one or more buy-side firms or other entities. For example, a sell-side firm may learn how their assets, documents, and/or other information items were utilized externally, how their services were rated, both as a whole, and by individual analyst within their firm, or be provided with other information. A sell-side firm may further be provided with data that enables them to see how they compare with other sell-side service providers.

In some implementations, a buy-side firm may control/manage how much feedback a particular sell-side firm is entitled to see. In other implementations, the service provider or other entity maintaining RMS 200 may control what feedback a sell-side firm is entitled to review. In some instances, a sell-side firm may receive only ratings and other feedback on their services alone. Alternatively, a sell-side firm may receive ratings and feedback on other sell-side firms as well if, in exchange, it is willing to allow its own ratings to be provided to other sell-side firms for comparison. Further, a sell-side firm may limit what a user (e.g., a sell-side analyst) within the firm may see. Various “opt-in”/“opt-out” models may be implemented for data exchange among the various users/entities accessing RMS 200.

For example, in one implementation, a selPside firm may receive blind-ratings indicating how they have been ranked by one or more buy-side firms. A sell-side firm may, for instance, learn that they have been ranked 3^{rd} overall by a first buy-side firm, 6^{th} overall by a second buy-side firm, and 1^{st} overall by a third buy-side firm, etc. They may not, however, know who has been ranked above and/or below them by each buy-side firm. A sell-side firm may also receive an indication of how they have been ranked by all buy-side firms (e.g., 3^{rd} overall by all buy-side firms) without learning the identity of the other sell-side firms ranked above and/or below them.

In one exemplary implementation, a sell-side firm may “opt-in” to a group that enables them to view their ranking vis-à-vis the ranking of other sell-side firms that have opted into the group. For example, if sell-side firm A, sell-side firm B, and sell-side fine C have opted into the group, each may be able to view one another's rankings (and identity), but no others. For example, sell-side fine A may learn that they have been ranked 4^{th} overall by a given buy-side firm, and that the same buy-side firm has ranked sell-side firm B 6^{th} overall, and sell-side firm C 2^{nd} overall. In an alternative implementation, all sell-side firms may automatically be included in such a group, thereby requiring an affirmative “opt-out” action if they wish to have their identity concealed from other sell-side firms.

According to an aspect of the invention, within a sell-side firm, internal access controls may determine which users can access which information. For example, a sell-side director of research (or other user) may have access to all ratings and other feedback, while a sell-side analyst may only be able to view his/her own ratings and feedback.

Similar to the implementations described above with regard to sell-side firms, sell-side analysts (or other users) within a sell-side firm may view blind ratings (e.g., an analyst may learn only that they have been ranked 3^{rd} overall within their firm by a given buy-side firm, or 6^{th} overall by all buy-side firms). Sell-side analysts may also choose to “opt-in”/“opt-out” of a group of sell-side analysts in their firm (or across a number of firms) which would enable them to see their rankings vis-à-vis the rankings (and identities) of others in the same group. Other implementations may be utilized.

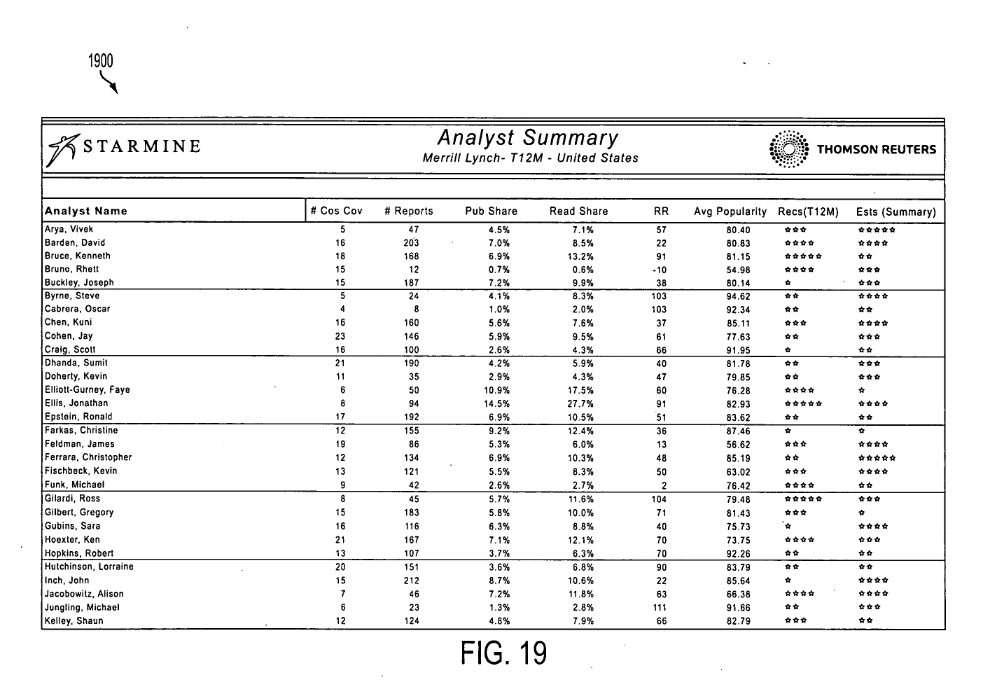

According to an aspect of the invention, a sell-side research director (or other user) may view data concerning consumption of research, trade ideas, models, etc. to aid in determining the value of information that the sell-side firm is producing. Usage is tracked and displayed to be as actionable as possible. For example, as shown in view 1900 of FIG. 19, metrics (e.g., total number of reports, read share, average popularity and other ratings, etc.) on one or more analysts associated with the sell-side firm, for a given time period, may be displayed to enable the sell-side research director to identify high-performing analysts as well as under-performing analysts. The sell-side research director may determine whether or not share this data with the analysts.

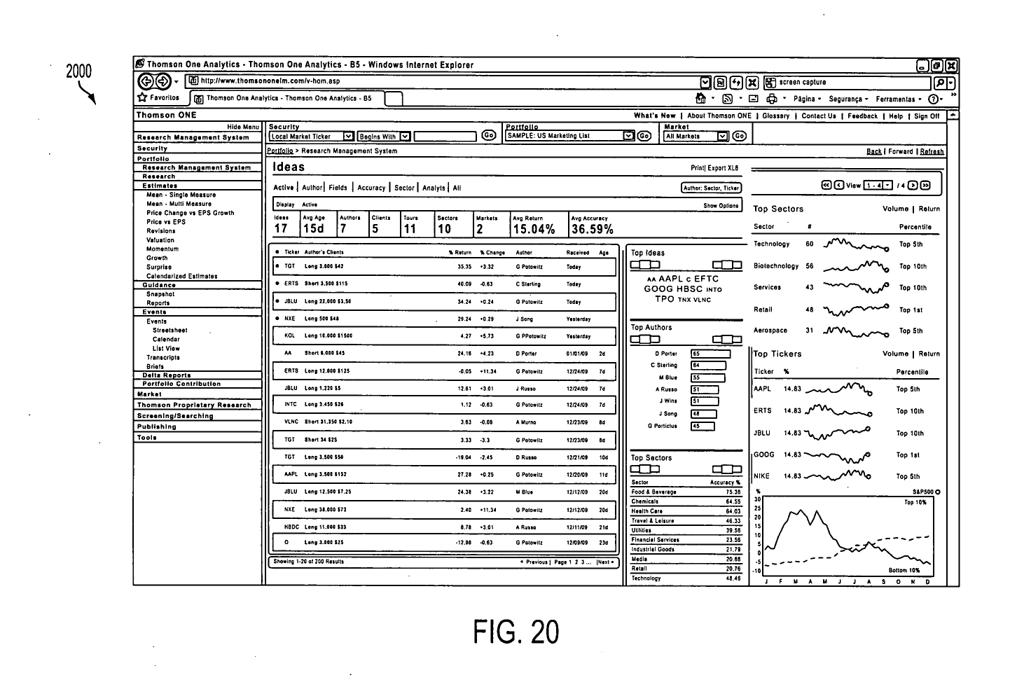

Additionally, as shown in view 2000 of FIG. 20, a sell-side research director may view additional metrics including, for example, volume and performance of trade ideas generated by the sell-side firm, as well as execution attributed to the trade ideas. Volume and performance of trade ideas may also be managed.

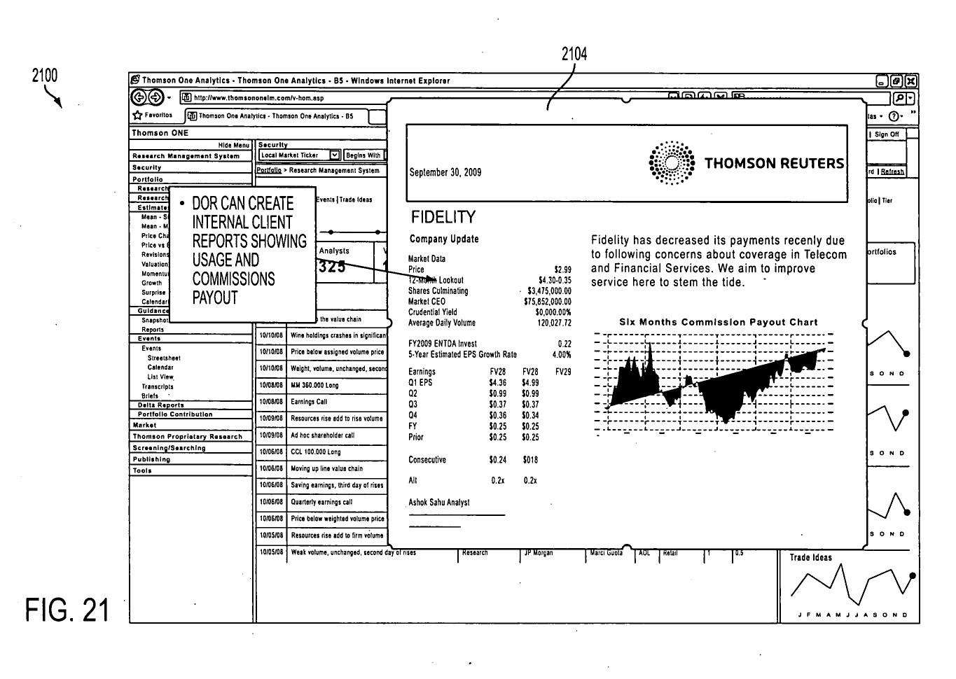

Based on the foregoing data, the sell-side research director may then manage internal resources based on what information/services are most used and valued. For example, as illustrated in view 2100 of FIG. 21, internal reports (e.g., report 2104) may be generated to evaluate trends for particular clients over time. Report 2104 may provided to selected users within the sell-side firm to address why a particular client has increased and/or decreased commission payouts over time. These reports may additionally be used and/or incorporated into performance reviews for analysts, salespeople, etc.

Additionally, reports may be generated for commission discussions with clients. A sell-side firm may, for example, point to favorable usage and ratings data (from the client) when pushing for greater commissions payouts from a client. Other advantages may be realized.

In addition to sell-side firms and buy-side firms, other financial services professionals or individuals, whether independent or associated with some entity (e.g., 170a) such as a Financial Information Services Provider (FISP) or other entity, may also access RMS 200 for various purposes. Individuals employed by the service provider or other entity that provides and/or maintains RMS 200 may also utilize RMS 200. In one example, wealth managers may use RMS 200 to share ratings and comments with the advisors in their firm. Corporate officers may also use RMS 200 to access and review research on their companies as well as to provide feedback to research providers (e.g., to correct inaccuracies or provide information). Corporate officers may also use RMS 200 to make inquiries to targeted investors on the buy-side (e.g., and to provide them with favorable research reports), as well as to answer questions asked by other individuals or firms. External financial experts (similar to brokers) that produce research reports on a subscription or pay-per-view basis may also use RMS 200 to allow feedback on research to be leveraged in the same way as for sell-siders as described herein. Individuals and/or entities engaged in the business of providing and distributing dynamic (financial) news and reports may also utilize the features and functionality of RMS 200.

Other embodiments, uses and advantages of the invention will be apparent to those skilled in the art from consideration of the specification and practice of the invention disclosed herein. The specification should be considered exemplary only, and the scope of the invention is accordingly intended to be limited only by the following claims.

What is claimed is:

1. A computer-implemented method for rating securities research, the method executed by one or more processors configured to perform a plurality of operations, the operations comprising:
receiving a sell-side document, the sell-side document having been generated by a first entity conducting sell-side activities;
receiving a first buy-side rating on at least a first asset included in the sell-side document, the first buy-side rating having been generated by a second entity conducting buy-side activities;
storing the first buy-side rating in a memory; and
providing access to the first buy-side rating to one or more users at the first entity.

2. The method of claim 1, further comprising:
receiving a second buy-side rating on the first asset, the second buy-side rating having been generated by the second entity;
generating an aggregate buy-side rating score for the first asset based on the first buy-side rating and the second buy-side rating;
storing the aggregate buy-side rating score; and
providing access to the aggregate buy-side rating score to one or more users at the first entity.

3. The method of claim 2, wherein the first buy-side rating and the second buy-side rating are normalized prior to generating the aggregate buy-side rating score.

4. The method of claim 2, further comprising
receiving a third buy-side rating on a second asset included in the sell-side document, the third buy-side rating having been generated by the second entity;
receiving a fourth buy-side rating on the second asset, the fourth buy-side rating having been generated by the second entity;
generating a second aggregate buy-side rating score for the second asset based on the third buy-side rating and the fourth buy-side rating;
storing the second aggregate buy-side rating score; and
providing access to the second aggregate buy-side rating score to one or more users at the first entity.

5. The method of claim 1, further comprising:
receiving, from the second entity, one or more comments on the sell-side document; and
providing access to the one or more comments to one or more users at the second entity.

6. The method of claim 1, wherein the sell-side document comprises a securities research report.

7. The method of claim 1, wherein the sell-side document comprises a trade idea.

8. The method of claim 1, wherein the first asset comprises at least one of a portion of text, a chart, a table, or a spreadsheet.

9. The method of claim 4, wherein the first asset comprises a portion of text, and the second asset comprises a chart.

10. The method of claim 1, further comprising:
receiving, via a user interface, a command to dynamically access the first asset of the sell-side document from a user associated with the second entity; and
launching, in the user interface, the first asset in an instance of an application used to generate the first asset in response to the received command.

11. The method of claim 10, further comprising:
tracking, via a counter, the number of times the first asset of the sell-side document has been dynamically accessed by a user associated with the second entity.

12. The method of claim 10, further comprising:
receiving modifications to the first asset from the user; and
storing the modified first asset as a new asset.

13. The method of claim 12, further comprising:
enabling the user to incorporate either or both of the first asset and the new asset in a buy-side document.

14. The method of claim 10, further comprising:
tracking, via a counter, the number of times the first asset of the sell-side document has been dynamically accessed by a user associated with the second entity, modified, and stored as a new asset.

15. The method of claim 1, wherein providing access comprises:
transmitting an electronic mail message to one or more users at the first entity.

16. The method of claim 1, wherein access is provided via a web-based application.

17. The method of claim 1, further comprising:
displaying the first buy-side rating, via a user interface, to one or more users at the second entity.

18. A system for rating securities research, comprising:
one or more processors; and
a memory communicatively coupled to the one or more processors, wherein the memory includes one or more sequences of one or more instructions which, when executed by the one or more processors, cause the one or more processors to perform the steps of:
receiving a sell-side document, the sell-side document having been generated by a first entity conducting sell-side activities;
receiving a first buy-side rating on at least a first asset included in the sell-side document, the first buy-side rating having been generated by a second entity conducting buy-side activities;
storing the first buy-side rating in a memory; and
providing access to the first buy-side rating to one or more users at the first entity.

19. The system of claim 18, wherein the one or more processors further perform the steps of:
receiving a second buy-side rating on the first asset, the second buy-side rating having been generated by the second entity;
generating an aggregate buy-side rating score for the first asset based on the first buy-side rating and the second buy-side rating;
storing the aggregate buy-side rating score; and
providing access to the aggregate buy-side rating score to one or more users at the first entity.

20. The system of claim 19, wherein the first buy-side rating and the second buy-side rating are normalized prior to generating the aggregate buy-side rating score.

21. The system of claim 19, wherein the one or more processors further perform the steps of:
receiving a third buy-side rating on a second asset included in the sell-side document, the third buy-side rating having been generated by the second entity;
receiving a fourth buy-side rating on the second asset, the fourth buy-side rating having been generated by the second entity;
generating a second aggregate buy-side rating score for the second asset based on the third buy-side rating and the fourth buy-side rating;
storing the second aggregate buy-side rating score; and
providing access to the second aggregate buy-side rating score to one or more users at the first entity.

22. The system of claim 18, wherein the one or more processors further perform the steps of:
receiving, from the second entity, one or more comments on the sell-side document; and
providing access to the one or more comments to one or more users at the second entity.

23. The system of claim 18, wherein the sell-side document comprises a securities research report.

24. The system of claim 18, wherein the sell-side document comprises a trade idea.

25. The system of claim 18, wherein the first asset comprises at least one of a portion of text, a chart, a table, or a spreadsheet.

26. The system of claim 21, wherein the first asset comprises a portion of text, and the second asset comprises a chart.

27. The system of claim 18, wherein the one or more processors further perform the steps of:
receiving, via a user interface, a command to dynamically access the first asset of the sell-side document from a user associated with the second entity; and
launching, in the user interface, the first asset in an instance of an application used to generate the first asset in response to the received command.

28. The system of claim 27, wherein the one or more processors further perform the step of:
tracking, via a counter, the number of times the first asset of the sell-side document has been dynamically accessed by a user associated with the second entity.

29. The system of claim 27, wherein the one or more processors further perform the steps of:
receiving modifications to the first asset from the user; and
storing the modified first asset as a new asset.

30. The system of claim 29, wherein the one or more processors further perform the step of:
enabling the user to incorporate either or both of the first asset and the new asset in a buy-side document.

31. The system of claim 27, wherein the one or more processors further perform the step of:
tracking, via a counter, the number of times the first asset of the sell-side document has been dynamically accessed by a user associated with the second entity, modified, and stored as a new asset.

32. The system of claim 18, wherein the one or more processors further perform the step of:
transmitting an electronic mail message to one or more users at the first entity.

33. The system of claim 18, wherein access is provided via a web-based application.

34. The system of claim 18, wherein the one or more processors further perform the step of:
displaying the first buy-side rating, via a user interface, to one or more users at the second entity.
